(19) United States
(12) Patent Application Publication
(10) Pub. No.: US 2026/0170739 A1
(43) Pub. Date: Jun. 18, 2026

(54) ELECTRONIC DEVICE, METHOD, AND NON-TRANSITORY COMPUTER READABLE STORAGE MEDIUM FOR GENERATING MOVING IMAGE BASED ON STILL IMAGE

(71) Applicant: SAMSUNG ELECTRONICS CO., LTD., Suwon-si (KR)

(72) Inventors: Jongkyu KIM, Suwon-si (KR); Kyuwon KIM, Suwon-si (KR); Jongkwang KIM, Suwon-si (KR); Hyunsoo KIM, Suwon-si (KR); Chulju YANG, Suwon-si (KR); Albert SAA-GARRIGA, Staines (GB); Wayne PRICE, Staines (GB)

(21) Appl. No.: 19/343,093

(22) Filed: Sep. 29, 2025

Related U.S. Application Data
(63) Continuation of application No. PCT/KR2025/013613, filed on Sep. 3, 2025.

(30) Foreign Application Priority Data
Dec. 16, 2024 (KR) 10-2024-0187773
Mar. 28, 2025 (KR) 10-2025-0040729

(51) Int. Cl. G06T 13/20; G06T 5/77; G06T 19/20

(52) U.S. Cl. CPC G06T 13/20; G06T 5/77; G06T 19/20; G06T 2219/2004

(57) ABSTRACT

An electronic device may obtain two-dimensional information regarding at least one object from a still image. The electronic device, using the two-dimensional information, may identify a type of the at least one object related to a three-dimensional motion effect of the at least one object. The electronic device may generate a moving image including the three-dimensional motion effect of the at least one object based on a motion model corresponding to the type of the at least one object.

### CROSS-REFERENCE TO RELATED APPLICATIONS

This application is a continuation application of International Application No. PCT/KR2025/013613, filed on Sep. 3, 2025, in the Korean Intellectual Property Receiving Office, and claiming priority to Korean Patent Application No. 10-2024-0187773 filed Dec. 16, 2024, and Korean Patent Application No. 10-2025-0040729 filed Mar. 28, 2025, the disclosures of which are all hereby incorporated by reference herein in their entireties.

### TECHNICAL FIELD

Certain example embodiments may relate to an electronic device, a method, and/or a non-transitory computer readable storage medium for generating a moving image based on a still image.

### BACKGROUND

An electronic device may provide multiple functions. For example, the electronic device may generate an image using an artificial intelligence (AI) model. For example, the electronic device may generate an image (e.g., a still image or a moving image) based on inputting a text prompt to a generative AI model.

### SUMMARY

An electronic device in certain example embodiments may comprise at least one processor comprising processing circuitry, and memory, comprising one or more storage mediums, storing instructions. The instructions, when executed by the at least one processor individually and/or collectively, may cause the electronic device to obtain two-dimensional information regarding at least one object from a still image. The instructions, when executed by the at least one processor individually and/or collectively, may cause the electronic device to, using the two-dimensional information, identify a type of the at least one object related to a three-dimensional motion effect of the at least one object. The instructions, when executed by the at least one processor individually and/or collectively, may cause the electronic device to generate a moving image including the three-dimensional motion effect of the at least one object based on a motion model corresponding to the type of the at least one object.

An electronic device according to certain example embodiments may comprise a display, at least one processor comprising processing circuitry, and memory, comprising one or more storage mediums, storing instructions. The instructions, when executed by the at least one processor individually and/or collectively, may cause the electronic device to identify an object in a still image including one or more objects. The instructions, when executed by the at least one processor individually and/or collectively, may cause the electronic device to identify a motion model corresponding to a motion property to be applied to a three dimensional (3D) object corresponding to the identified object. The motion property may include one or more motion types among a plurality of motion types. The instructions, when executed by the at least one processor individually and/or collectively, may cause the electronic device to display a first frame including the 3D object corresponding to the object at a first position via the display. The instructions, when executed by the at least one processor individually and/or collectively, may cause the electronic device to update a position of the 3D object according to motion information of the 3D object from the motion model. The instructions, when executed by the at least one processor individually and/or collectively, may cause the electronic device to display, via the display, a second frame including the 3D object at a second position instead of the first position according to the motion information, following the first frame.

An example method may be performed by an electronic device, and may comprise obtaining, by the electronic device two-dimensional information regarding at least one object from a still image. The method may comprise, using the two-dimensional information, identifying a type of the at least one object related to a three-dimensional motion effect of the at least one object. The method may comprise generating a moving image including the three-dimensional motion effect of the at least one object based on a motion model corresponding to the type of the at least one object.

An example method performed by an electronic device may comprise identifying an object in a still image including one or more objects. The method may comprise identifying a motion model corresponding to a motion property to be applied to a three dimensional (3D) object corresponding to the identified object. The motion property may include one or more motion types among a plurality of motion types. The method may comprise displaying a first frame including the 3D object corresponding to the object at a first position via a display. The method may comprise updating a position of the 3D object according to motion information of the 3D object from the motion model. The method may comprise displaying, via the display, a second frame including the 3D object at a second position instead of the first position according to the motion information, following the first frame.

An example non-transitory computer readable storage medium may store a program including instructions. The instructions, when executed by at least one processor individually and/or collectively, may cause an electronic device to obtain two-dimensional information regarding at least one object from a still image. The instructions, when executed by the at least one processor individually and/or collectively, may cause the electronic device to, using the two-dimensional information, identify a type of the at least one object related to a three-dimensional motion effect of the at least one object. The instructions, when executed by the at least one processor individually and/or collectively, may cause the electronic device to generate a moving image including the three-dimensional motion effect of the at least one object based on a motion model corresponding to the type of the at least one object.

An example non-transitory computer readable storage medium may store a program including instructions. The instructions, when executed by at least one processor individually and/or collectively, may cause an electronic device to identify an object in a still image including one or more objects. The instructions, when executed by the at least one processor individually and/or collectively, may cause the electronic device to identify a motion model corresponding to a motion property to be applied to a three-dimensional (3D) object corresponding to the identified object. The motion property may include one or more motion types among a plurality of motion types. The instructions, when executed by the at least one processor individually and/or collectively, may cause the electronic device to display a first frame including the 3D object corresponding to the object at a first position via the display. The instructions, when executed by the at least one processor individually and/or collectively, may cause the electronic device to update a position of the 3D object according to motion information of the 3D object from the motion model. The instructions, when executed by the at least one processor individually and/or collectively, may cause the electronic device to display, via the display, a second frame including the 3D object at a second position instead of the first position according to the motion information, following the first frame.

### BRIEF DESCRIPTION OF THE DRAWINGS

FIG. 1 is a block diagram of an electronic device in a network environment according to various example embodiments.

FIG. 2 is a block diagram of an electronic device according to an example embodiment.

FIG. 3 is a diagram indicating an operation in which an electronic device generates a moving image according to an example embodiment.

FIG. 4 is a diagram indicating a still image according to an example embodiment.

FIG. 5 is a diagram indicating an operation of generating data related to a 3D object according to an example embodiment.

FIG. 6A is a diagram indicating an example of a frame included in a moving image according to an example embodiment.

FIG. 6B is a diagram indicating an example of a frame included in a moving image according to an example embodiment.

FIG. 7A is a diagram indicating an example of a frame included in a moving image generated by a real-time input, according to an example embodiment.

FIG. 7B is a diagram indicating an example of a frame included in a moving image generated by a real-time input, according to an example embodiment.

FIG. 8A is a diagram indicating an example of a frame included in a moving image generated by a real-time input, according to an example embodiment.

FIG. 8B is a diagram indicating an example of a frame included in a moving image generated by a real-time input, according to an example embodiment.

FIG. 9A is a diagram indicating an example of a frame included in a moving image displayed in a gallery application, according to an example embodiment.

FIG. 9B is a diagram indicating an example of a frame in specified content of a gallery application, according to an example embodiment.

FIG. 10A is a diagram indicating an example of a lock screen displayed in a locked state of an electronic device, according to an example embodiment.

FIG. 10B is a diagram indicating an example of a user input for releasing a locked state of an electronic device according to an example embodiment.

FIG. 11A is a diagram indicating an example of a frame displayed according to a notification of an electronic device, according to an example embodiment.

FIG. 11B is a diagram indicating an example of a frame displayed according to a notification of an electronic device, according to an example embodiment.

FIG. 12 is a flowchart indicating an operation in which an electronic device determines acceleration according to a real-time input, according to an example embodiment.

FIG. 13 is a flowchart indicating an operation of an electronic device, according to an example embodiment.

FIG. 14 is a flowchart indicating an operation of an electronic device according to an example embodiment.

FIG. 15 is a diagram indicating an example of a frame displayed on a wearable device according to an example embodiment.

FIG. 16 is a diagram illustrating various types of electronic devices according to an example embodiment.

### DETAILED DESCRIPTION

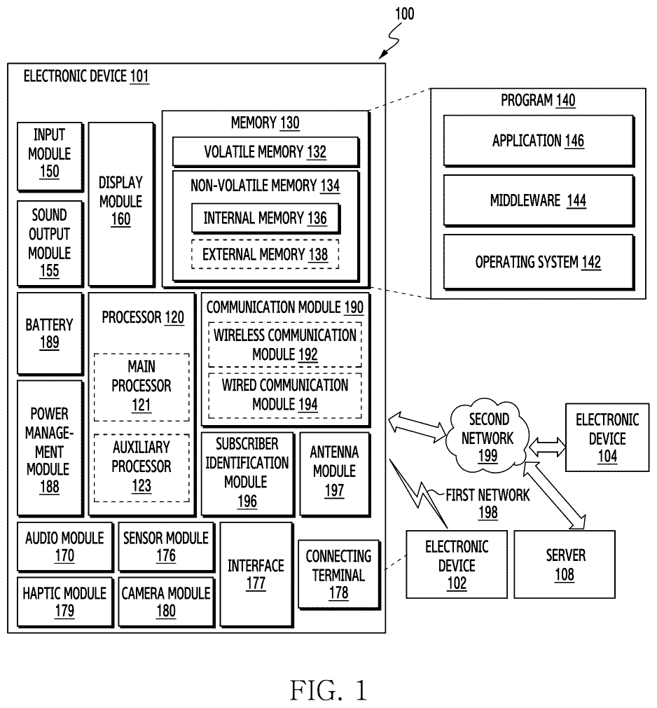

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Each “unit” herein may comprise circuitry.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device 101 may utilize a technology for estimating three-dimensional (3D) information from a two-dimensional (2D) image in relation to a computer vision algorithm. In particular, the electronic device 101 may estimate depth information from a single 2D image and then, by utilizing it, may utilize an algorithm that generates a 3D model. In particular, the electronic device 101 may estimate more precise depth information from the single 2D image by using a large amount of learning data through a deep learning-based depth estimation model. In this way, when utilizing the deep learning-based depth estimation model, the electronic device 101 may generate the 3D model by analyzing a shape and spatial disposition of an object in the single 2D image. In addition, the electronic device 101 may generate a moving image by generating and displaying frames rendered from the 3D model generated through graphics technology through the generated 3D model.

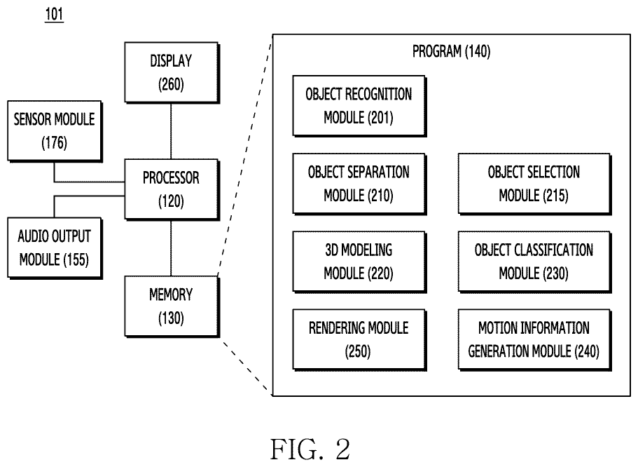

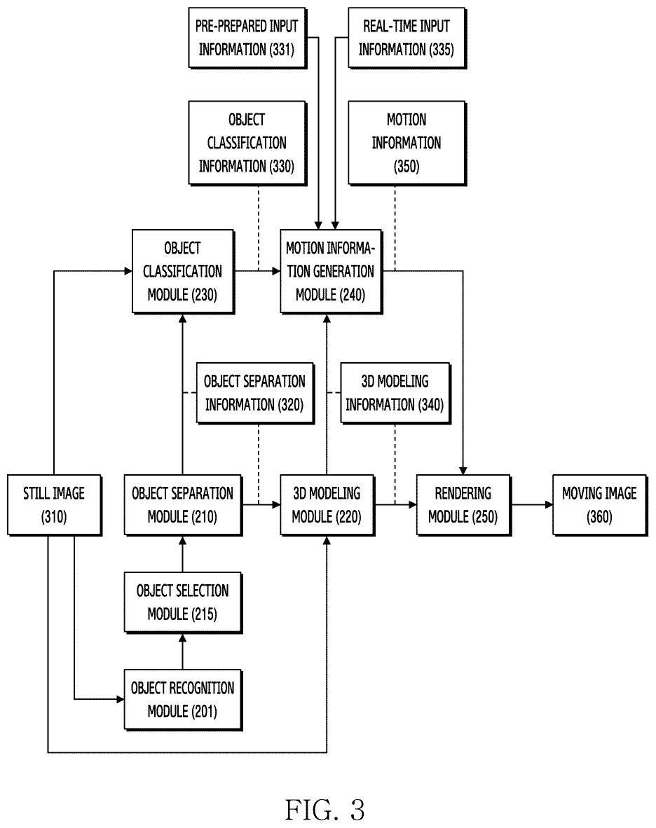

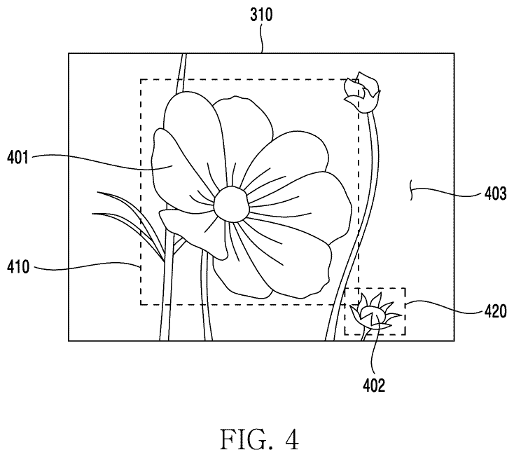

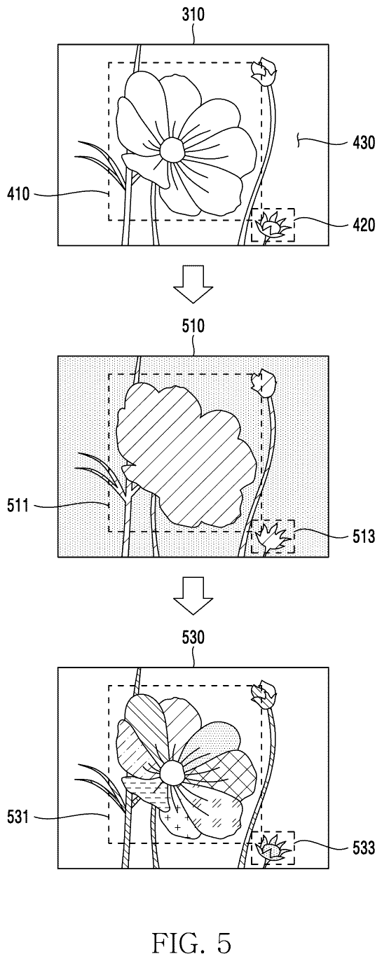

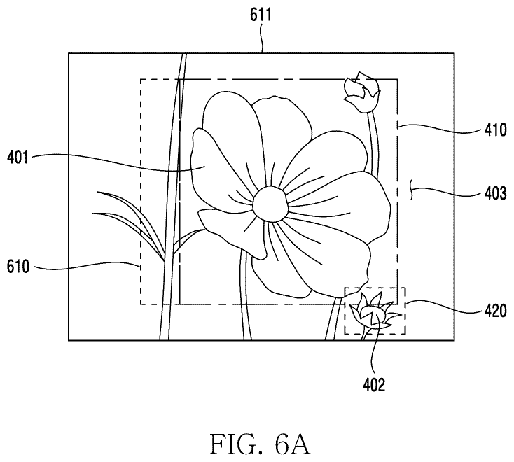

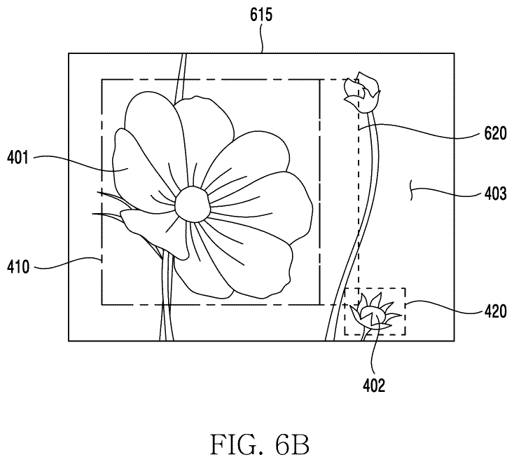

FIG. 2 is a block diagram of an electronic device according to an embodiment. FIG. 3 is a diagram indicating an operation in which an electronic device generates a moving image according to an embodiment. FIG. 4 is a diagram indicating a still image according to an embodiment. FIG. 5 is a diagram indicating an operation of generating data related to a 3D object according to an embodiment. FIG. 6A is a diagram indicating an example of a frame included in a moving image according to an embodiment. FIG. 6B is a diagram indicating an example of a frame included in a moving image according to an embodiment.

FIGS. 2 to 6B may be described with reference to FIG. 1.

Referring to FIG. 2, an electronic device 101 may include a processor 120, memory 130, an audio output module 155, a sensor module 176, and a display 260. In an embodiment, the display 260 may correspond to the display module 160 of FIG. 1.

In an embodiment, the memory 130 may include, as a program 140, an object recognition module 201, an object separation module 210, an object selection module 215, a three-dimensional (3D) modeling module 220, an object classification module 230, a motion information generation module 240, and a rendering module 250. In an embodiment, the object recognition module 201, the object separation module 210, the object selection module 215, the 3D modeling module 220, the object classification module 230, the motion information generation module 240, and/or the rendering module 250 may include instructions. In an embodiment, instructions of the object recognition module 201, the object separation module 210, the object selection module 215, the 3D modeling module 220, the object classification module 230, the motion information generation module 240, and/or the rendering module 250 may be executed by the processor 120. According to an embodiment, at least one module may be further added to the electronic device 101. According to an embodiment, one or more modules among modules included in the electronic device 101 may be integrated into one module. For example, the object recognition module 201 and the object separation module 210 may be integrated into one module.

In an embodiment, functions performed by at least one module among the object recognition module 201, the object separation module 210, the 3D modeling module 220, the object classification module 230, the motion information generation module 240, and/or the rendering module 250 may be performed by an artificial intelligence model. For example, the functions of at least one module among the object recognition module 201, the object separation module 210, the 3D modeling module 220, the object classification module 230, the motion information generation module 240, and/or the rendering module 250 described below may be performed by the artificial intelligence model. For example, the object recognition module 201 may recognize an object in an image through the artificial intelligence model trained to recognize objects in images. For example, the object separation module 210 may separate an object from an image through the artificial intelligence model trained to separate objects from images.

In an embodiment, the electronic device 101 may generate an output image (or a moving image) interactable with a user from an input image (or a still image) through the object recognition module 201, the object separation module 210, the object selection module 215, the 3D modeling module 220, the object classification module 230, the motion information generation module 240, and/or the rendering module 250. In an embodiment, the electronic device 101 may generate the output image (or the moving image) in which a motion effect is applied to one or more objects included in the input image (or the still image). In an embodiment, the electronic device 101 may generate the output image (or the moving image) in which the motion effect is applied to the one or more objects using information in the input image (or the still image) and/or information obtainable by the electronic device 101, in relation to a motion of the one or more objects. In an embodiment, the input image may be referred to as a two-dimensional (2D) image, an original image, or at least one frame among one or more frames in a moving image. In an embodiment, the one or more objects may be referred to as an object selected by a user input and an object satisfying a specified condition. In an embodiment, the output image may be referred to as a moving image, a motion image, or an image (e.g., an image capable of playing (movement of) at least a partial area) interactable with the user.

Hereinafter, referring to FIGS. 3 to 6B, an operation in which the electronic device 101 generates the output image (or the moving image) from the input image (or the still image) through the object recognition module 201, the object separation module 210, the object selection module 215, the 3D modeling module 220, the object classification module 230, the motion information generation module 240, and the rendering module 250 may be described. Hereinafter, the object recognition module 201 and the object separation module 210 are exemplified as separate modules, but according to an embodiment, the object recognition module 201 and the object separation module 210 may be integrated into one module.

In an embodiment, the object recognition module 201 may receive an input image. In an embodiment, referring to FIG. 3, the object recognition module 201 may receive a still image 310 as the input image. However, an embodiment is not limited thereto. For example, the object recognition module 201 may receive two or more still images as the input image. For example, the object recognition module 201 may receive a moving image (or at least one frame among frames in the moving image) as the input image.

In an embodiment, the object recognition module 201 may receive a user input for the input image together with the input image (e.g., the still image 310). In an embodiment, the user input for the input image may be an input for adding at least one object on the input image. For example, the user input for the input image may indicate a drawing object for adding an object on the input image. For example, the user input for the input image may include a prompt for adding an object on the input image. In an embodiment, the prompt may include text and/or a drawing describing the object to be added on the input image. For example, the artificial intelligence model may add the object on the input image based on the prompt.

For example, the object recognition module 201 may receive a user input (e.g., a drawing or a prompt (e.g., text or a drawing)) for adding a butterfly on a flower in an input image including the flower as an object. For example, the object recognition module 201 may add the butterfly according to the user input around the flower of the input image through the artificial intelligence model. In an embodiment, an object added to the input image by the user input may be identified as an object capable of interacting with the user. For example, the butterfly, which is an object added to the input image by the user input, may move in the output image in relation to the movement of the flower (e.g., shaking by wind, shaking by a user input, or shaking regarding a state of the electronic device 101).

In an embodiment, the object recognition module 201 may recognize one or more objects in the still image 310. For example, referring to FIG. 4, the object recognition module 201 may recognize (or identify) one or more objects 401 and 402 and a background 403 in the still image 310. In an embodiment, the one or more objects 401 and 402 and the background 403 may have different depth values. In an embodiment, the depth value may indicate a distance between a camera and a subject when the still image 310 is obtained. The one or more objects 401 and 402 (or areas, or portions) may be a plurality of foreground objects (e.g., a person, an animal, and an object). In an embodiment, the background 402 may be referred to as a background object as areas other than the plurality of foreground objects (e.g., a person, an animal, and an object).

For example, the object recognition module 201 may recognize (or identify) a position (or a center position) (or a boundary) of each of the one or more objects 401 and 402 in the still image 310 and/or an area of each of the one or more objects 401 and 402 in the still image 310. For example, the object recognition module 201 may generate bounding boxes 410 and 420 indicating the position and/or the area of each of the one or more objects 401 and 402 in the still image 310. In an embodiment, the bounding boxes 410 and 420 may be substantially rectangular virtual boxes including an identified object. In an embodiment, the bounding boxes 410 and 420 may be the smallest boxes that may include each of the identified one or more objects. In an embodiment, the bounding boxes 410 and 420 are not limited to a rectangle and may have various shapes.

In an embodiment, the object selection module 215 may select at least one object of interest among the identified one or more objects 401 and 402. For example, the object selection module 215 may display a user interface (UI) for querying an object to which a motion effect is to be applied among the identified one or more objects 401 and 402 through the display 260. In an embodiment, the object selection module 215 may select an object of interest corresponding to a user input according to the user input for selecting at least one of the identified one or more objects 401 and 402. In FIG. 3, it is exemplified that processing for the still image 310 is performed in an order of the object recognition module 201, the object selection module 215, and the object separation module 210, but this is only an example. According to an embodiment, after object recognition by the object recognition module 201 and object separation by the object separation module 210, an object may be selected through the object selection module 215.

In an embodiment, the object separation module 210 may separate (or segment) each of the one or more objects 401 and 402 identified in the still image 310 from the still image 310. For example, the object separation module 210 may separate (or segment) pixels indicating an area of each of the identified one or more objects 401 and 402 among pixels of the still image 310 from a moving image.

In an embodiment, the object separation module 210 may identify object information of each of the one or more objects 401 and 402 separated from the still image 310. In an embodiment, the object separation module 210 may identify object information of the object in the bounding boxes 410 and 420. In an embodiment, the object information may indicate a type of the object.

In an embodiment, the object separation module 210 may generate object separation information 320. In an embodiment, the object separation information 320 may include data and object information indicating the pixels indicating the area of each of the identified one or more objects 401 and 402.

In an embodiment, the object separation module 210 may generate the object separation information 320 for the object of interest among the identified one or more objects 401 and 402. In an embodiment, the object of interest may be an object selected by a user input or an object satisfying a specified condition. Hereinafter, at least one object selected (or satisfying the specified condition) by the user input may be referred to as the object of interest.

In an embodiment, the object separation module 210 may generate the object separation information 320 for the at least one object of interest selected by the user input among the identified one or more objects 401 and 402.

For example, the object separation module 210 may generate the object separation information 320 for the object of interest satisfying the specified condition among the identified one or more objects 401 and 402. In an embodiment, the object of interest (or a main object) may be a main subject determining a subject of the still image 310. In an embodiment, the object of interest (or the main object) may be a main subject positioned at a point of interest (e.g., gaze direction) according to each of photographing compositions (e.g., a C-shape, a V-shape, an S-curve, an L-shape, a golden spiral, and a diagonal) in a field of view (FoV) of the still image 310.

In an embodiment, the object separation module 210 may determine the number of objects of interest to which a motion effect is to be applied in the still image 310. In an embodiment, the object separation module 210 may determine only one of the plurality of objects 401 and 402 included in the still image 310 as an object of interest to which the motion effect is to be applied. In an embodiment, the object separation module 210 may determine two or more objects among the plurality of objects 401 and 402 included in the still image 310 as objects of interest to which the motion effect is to be applied.

In an embodiment, the object separation module 210 may determine at least one object among two or more objects as the object of interest. For example, the object classification module 230 may determine at least one object as the object of interest based on a relationship (a relationship (e.g., couple, parent-child, friend, colleague) between subjects represented by the objects, a property (e.g., a type (e.g., a person, an animal, or an object) of a subject indicated by the object), a subject of interest specified by the user, a type of a motion of the object, and range of the motion of the object) between each of the two or more objects, and/or priorities.

For example, in a case that an object has specified depth information, the object separation module 210 may determine the object as the object of interest satisfying the specified condition. For example, the object separation module 210 may identify an object satisfying the specified condition among the identified one or more objects 401 and 402 as the object of interest based on depth information (e.g., a depth map) of the still image 310. For example, referring to FIG. 5, based on a depth map 510 of the still image 310, an object 511 positioned at the frontmost among objects 511 and 513 may be identified as the object of interest satisfying the specified condition.

For example, in a case that an object is a salient object, the object separation module 210 may determine the object as the object of interest satisfying the specified condition. For example, the object separation module 210 may identify an object of which a degree of saliency exceeds a specified degree as the object of interest satisfying the specified condition based on a salient object detection (SOD) algorithm. For example, the object separation module 210 may detect the salient object as the object of interest based on the still image 310 (or the depth map 510) by using an artificial intelligence model trained to detect the salient object through a training data set. In an embodiment, the salient object detection algorithm (SOD) may be an algorithm that detects the salient object (or an attention-grabbing object) in the still image 310 (or the depth map 510) and segments an area including the detected object from the still image 310 (or the depth map 510). For example, the salient object detection algorithm (SOD) may be an algorithm that detects and segments the most salient object (or objects having the same properties) among objects that configure a foreground other than a background in the still image 310 (or the depth map 510). For example, the salient object detection algorithm (SOD) may select candidate salient object clusters classified (e.g., classified through spectral clustering) according to a specified criterion (e.g., similarity) among objects in the still image 310 (or the depth map 510). For example, the salient object detection algorithm (SOD) may select at least one candidate salient object cluster among the selected candidate salient object clusters. For example, the salient object detection algorithm (SOD) may select one or more candidate salient objects classified into the at least one candidate salient object cluster as salient objects. For example, objects (e.g., people) in an image that perform the same action (e.g., a soccer game) may be evaluated as having the same property.

In an embodiment, the object separation module 210 may transmit the object separation information 320 to the 3D modeling module 220 and/or the object classification module 230. For example, the object separation module 210 may transmit the object separation information 320 on the object of interest 401 to the 3D modeling module 220 and/or the object classification module 230. Hereinafter, for explanation, it may be exemplified that the object 401 among the one or more objects 401 and 402 identified in the still image 310 is selected as the object of interest.

In an embodiment, referring to FIG. 3, the 3D modeling module 220 may receive the still image 310. In an embodiment, the 3D modeling module 220 may receive the object separation information 320 from the object separation module 210. In an embodiment, the 3D modeling module 220 may receive the object separation information 320 on the object 401 selected from the object separation module 210.

In an embodiment, the 3D modeling module 220 may generate 3D model information 340 (or stereoscopic information) on the selected object 401 in the still image 310. In an embodiment, the 3D model information 340 (or the stereoscopic information) may indicate the selected object of interest 401 as a 3D object based on a plurality of meshes. In an embodiment, each of the plurality of meshes may include vertices, edges to which the vertices are connected, and a surface formed by the edges. In an embodiment, the 3D model information 340 (or the stereoscopic information) may include information on a 3D coordinate and/or a color of each of the vertices. In an embodiment, the 3D model information 340 (or the stereoscopic information) may include information on a texture of each of the meshes. In an embodiment, the 3D model information 340 (or the stereoscopic information) may indicate whether the 3D object is transformed.

In an embodiment, vertices, edges, and surfaces included in the 3D model information 340 (or the stereoscopic information) may include some vertices, some edges, and some surfaces, represented in the still image 310, and some other vertices, some other edges, and some other surfaces not represented in the still image 310. For example, the some other vertices, the some other edges, and the some other surfaces not represented in the still image 310 may be estimated (or identified) (or calculated) by the 3D modeling module 220 by a specified 3D graphics algorithm (e.g., a 3D reconstruction algorithm or a depth estimation algorithm). However, an embodiment is not limited thereto. For example, the 3D modeling module 220 may estimate (or identify) (or calculate) the some other vertices, the some other edges, and the some other surfaces that are not represented in the still image 310, by using an artificial intelligence model for constructing an object in the still image 310 as a 3D object. According to an embodiment, in a case that the still image 310 includes two or more still images, the 3D modeling module 220 may estimate (or identify) (or calculate) vertices, edges, and surfaces that represent time points that are not represented in the one still image 310 by using an artificial intelligence model (e.g., a structure from motion (SfM)) for constructing an object in a plurality of still images as a 3D object. In an embodiment, the two or more still images may include another photo stored in the memory 130 in addition to the still image 310. In an embodiment, the two or more still images may include another photo obtained from a server 108 (or a web search) in addition to the still image 310.

In an embodiment, the 3D modeling module 220 may identify a coordinate value in a depth direction of each of the objects 511 and 513 based on the depth map 510 of the still image 310. In an embodiment, the 3D modeling module 220 may identify a coordinate value in the depth direction of each of pixels included in the objects 511 and 513 based on the depth map 510 of the still image 310. In an embodiment, the 3D modeling module 220 may identify a three-dimensional coordinate of each of the vertices based on a coordinate value in the depth direction and coordinate values in horizontal and vertical directions in the still image 310.

In an embodiment, the 3D modeling module 220 may generate the 3D model information 340 (or the stereoscopic information) including edges to which the vertices are connected, and a surface formed by the edges, based on the three-dimensional coordinates of each of the vertices. For example, referring to FIG. 5, the 3D modeling module 220 may generate 3D model information 530 (or stereoscopic information) indicating 3D models 531 and 533 for the objects 511 and 513 based on a 3D coordinate of each of vertices for the objects 511 and 513.

In an embodiment, when generating the 3D model information 340 (or the stereoscopic information), the 3D modeling module 220 may generate the 3D model information 340 (or the stereoscopic information) including a vertex, edges, and a surface for a portion of the object 401 not displayed in the still image 310. For example, the 3D modeling module 220 may estimate the portion of the object 401 not displayed in the still image 310 through out-painting and generate the 3D model information 340 (or the stereoscopic information) including the vertex, the edges, and the surface for the estimated un-displayed portion of the object 401. For example, the out-painting may be performed using a specified artificial intelligence model (e.g., a diffusion model, a transformer model, or a generative adversarial network (GAN)).

In an embodiment, when generating the 3D model information 340 (or the stereoscopic information), the 3D modeling module 220 may generate the 3D model information 340 (or the stereoscopic information) of the object 401 by referring to another image including the object 401 (or another object corresponding to the object 401). In an embodiment, the other image including the object 401 (or the other object corresponding to the object 401) may be an image including the object 401 (or the other object corresponding to the object 401) at a different composition and/or a different angle from an input image. For example, the 3D modeling module 220 may identify the other image including the object 401 (or the other object corresponding to the object 401) among images captured within a specified time interval from a time point of capturing the input image. However, an embodiment is not limited thereto. For example, the 3D modeling module 220 may identify another image searched from the server 108 (or the Internet) using information on the object 401 included in the input image. In an embodiment, the other image may be a still image and/or a moving image.

In an embodiment, referring to the other image may include the 3D modeling module 220 identifying a coordinate value in the depth direction of each of the pixels included in objects based on a depth map of the other image and identifying a three-dimensional coordinate of each of the vertices based on a coordinate value in the depth direction and coordinate values in the horizontal and vertical directions in the other image. In an embodiment, referring to the other image may include, the 3D modeling module 220 generating the 3D model information 340 (or the stereoscopic information) of the object 401 by summing a 3D coordinate of each of the vertices identified through the still image 310 and a 3D coordinate of each of the vertices identified through the other image.

In an embodiment, when generating the 3D model information 340 (or the stereoscopic information) on the object 401, the 3D modeling module 220 may generate the 3D model information 340 (or the stereoscopic information) for another object related to the object 401. In an embodiment, the other object related to the object 401 may be an object linked to a motion of the object 401. For example, the other object related to the object 401 may be an object that guides, limits, or induces the motion of the object 401. For example, in a case that the object 401 is a balloon, the other object may be a string that ties the balloon. For example, in a case that the object 401 is a person, the other object may be a cane that the person is holding. For example, in a case that the object 401 is a person, the other object may be a hat that the person is wearing.

In an embodiment, the 3D modeling module 220 may transmit the 3D model information 340 to the motion information generation module 240 and/or the rendering module 250. For example, the 3D modeling module 220 may transmit the 3D model information 340 on the at least one object 401 selected by the user input to the 3D motion information generation module 240 and/or the rendering module 250. For example, the 3D modeling module 220 may transmit the 3D model information 340 on the object 401 satisfying the specified condition to the motion information generation module 240 and/or the rendering module 250.

According to an embodiment, the 3D modeling module 220 may store the 3D model information 340 in the memory 130 separately from a moving image 360. In an embodiment, the 3D modeling module 220 may reuse the 3D model information 340 stored in the memory 130 separately from the moving image 360. For example, reusing the 3D model information 340 may include generating a 3D model for an object included in another still image through the 3D model information 340 when generating a moving image based on the other still image other than the still image 310. In an embodiment, the other still image may be an image including the object 401 indicated by the 3D model information 340.

In an embodiment, the 3D modeling module 220 may update the 3D model information 340 stored in the memory 130 separately from the moving image 360. For example, updating the 3D model information 340 may include updating the 3D model information 340 through other 3D model information generated based on the other still image when generating the moving image based on the other still image other than the still image 310. In an embodiment, the other still image may be the image including the object 401 indicated by the 3D model information 340.

In an embodiment, the object classification module 230 may receive the still image 310. In an embodiment, the object classification module 230 may receive the object separation information 320 from the object separation module 210. In an embodiment, the object classification module 230 may receive the object separation information 320 for the selected object 401 from the object separation module 210. Each embodiment herein may be used in combination with any other embodiment(s) described herein.

In an embodiment, the object classification module 230 may define (or identify) a motion property related to the selected object 401. For example, the motion property of the selected object 401 may indicate one or more motion types (or one or more motion classifications) among a plurality of motion types (or a plurality of motion classifications). In an embodiment, the object classification module 230 may define (or identify) the one or more motion types (or the one or more motion classifications) to define a motion effect of the selected object 401 (or a 3D object corresponding to the object 401) among the plurality of motion types (or the plurality of motion classifications). For example, the motion type may be defined by one or more motions (e.g., a circular motion and a reciprocating motion), or a motion (e.g., an elastic motion, a sliding motion, a uniform motion, a free fall, and an accelerated motion) based on physical laws.

For example, the object classification module 230 may define (or identify) the motion property of the object 401 based on predefined data indicating motion properties corresponding to types of objects. For example, the predefined data may map a motion property indicating motion types applicable to an object for each type of object. For example, in a case that an object is a ‘ball’, the predefined data may map a motion property including a circular motion and a falling motion to the ‘ball’ as a motion type applicable to the ‘ball’. For example, in a case that an object is a ‘wheel’, the predefined data may map a motion property including a circular motion to the ‘wheel’ as a motion type applicable to the ‘wheel’. For example, in a case that an object is a ‘flower’ or ‘grass’, the predefined data may map a motion property including a reciprocating motion and an elastic motion to the ‘flower’ or the ‘grass’ as a motion type applicable to the ‘flower’ or the ‘grass’. For example, in a case that an object is a ‘skate’, the predefined data may map a motion property including a sliding motion to the ‘skate’ as a motion type applicable to the ‘skate’. For example, in a case that an object is a ‘cloud’ or ‘river’, the predefined data may map a motion property including a uniform motion to the ‘cloud’ or the ‘river’ as a motion type applicable to the ‘cloud’ or the ‘river’. For example, in a case that an object is a ‘waterfall’, the predefined data may map a motion property including a falling motion to the ‘waterfall’ as a motion type applicable to the ‘waterfall’.

For example, the object classification module 230 may define (or identify) the motion property including the reciprocating motion and the elastic motion as the motion type applicable to the ‘flower’ based on the object 401 being the ‘flower’.

According to an embodiment, the object classification module 230 may update the predefined data indicating motion properties corresponding to types of objects. For example, the object classification module 230 may identify a common object included in at least some images among one or more images stored in the memory 130 of the electronic device 101 (or a cloud database linked to a user account of the electronic device 101). For example, the object classification module 230 may obtain a motion property corresponding to a type of the identified common object. For example, the object classification module 230 may obtain the motion property corresponding to the type of the identified common object from the server 108. For example, the object classification module 230 may obtain the motion property corresponding to the type of the identified common object based on a user input obtained from a user interface (UI) that queries the motion property for the identified common object. In an embodiment, the object classification module 230 may add the obtained motion property corresponding to the type of the common object to the predefined data.

For example, the object classification module 230 may transmit object classification information 330 including a motion property to the motion information generation module 240.

In an embodiment, the motion information generation module 240 may receive the object classification information 330 from the object classification module 230. In an embodiment, the motion information generation module 240 may receive the 3D model information 340 from the 3D modeling module 220.

In an embodiment, the motion information generation module 240 may identify changed coordinate values of vertices of the 3D object corresponding to the object 401 based on the object classification information 330 and the 3D model information 340.

In an embodiment, the motion information generation module 240 may identify a motion model corresponding to the motion property of the object 401 according to the object classification information 330. In an embodiment, the motion information generation module 240 may generate motion information 350 on the object 401 by using the motion model for the object 401. In an embodiment, the motion information 350 may include information for converting a position of each of the vertices included in the 3D object corresponding to the object 401. For example, the information for converting the position may include a matrix (e.g., a rotation matrix) indicating a rotation and/or a matrix (e.g., a translation matrix) indicating a translation with respect to a three-dimensional coordinate of each of the vertices. In an embodiment, the motion model may include at least one of a motion model based on a position table, a motion model based on a position equation, and a motion model based on a physical equation.

In an embodiment, the position table may be a table in which position and time information are mapped. In an embodiment, the motion information generation module 240 may generate the motion information 350 on the object 401 using the position table. For example, the motion information generation module 240 may generate the motion information 350 indicating a position at each of one or more time points for the object 401 using the position table. In an embodiment, in a case that any one time point of the one or more time points is not defined in the position table, the motion information generation module 240 may identify a position at the any one time point using an interpolation (or extrapolation) algorithm. For example, in a case that any one time point of the one or more time points is not defined in the position table, the motion information generation module 240 may identify the position at the any one time point using positions for two neighboring time points at the any one time point.

According to the motion information 350 generated based on the position table as described above, a degree of motion freedom of the object 401 may be high. Accordingly, the motion information generation module 240 may generate the motion information 350 indicating various motions suitable for the object 401 based on the position table.

In an embodiment, the motion information generation module 240 may generate the motion information 350 using a position equation indicating a position of the object 401 according to a circular motion or a reciprocating motion.

For example, the motion information generation module 240 may generate the motion information 350 of the object 401 using a position equation for a circular motion such as Equation 1 below. For example, for an object (e.g., a wheel or a ball) that performs the circular motion, the motion information generation module 240 may generate the motion information 350 of the object 401 using the position equation for the circular motion such as Equation 1 below.

$${x}_{t} = {x}_{0} + r cos ( {w}_{0} + wt ) \qquad [ Equation 1 ]$$

$${y}_{t} = {y}_{0} + r sin ( {y}_{0} + w t )$$

Equation 1 may indicate positions xₜ and yₜ of the object 401 at a time point t. The positions xₜ and yₜ of the object 401 may be changed according to initial positions x₀ and y₀, an initial angle w₀, and an angular velocity w along a radius r.

For example, in a case that the object 401 (e.g., the wheel or the ball) moves at uniform velocity along a predetermined circular trajectory, the motion information generation module 240 may generate the motion information 350 of the object 401 based on Equation 1.

For example, the motion information generation module 240 may generate the motion information 350 of the object 401 using a position equation for a reciprocating motion such as Equation 2 below. For example, for an object (e.g., a flower, grass, or a tree performing a reciprocating motion by an external force (e.g., wind) in a specific direction) performing a reciprocating motion, the motion information generation module 240 may generate the motion information 350 of the object 401 using the position equation for the reciprocating motion such as Equation 2 below.

$${x}_{t}^{r e c} = \frac{b ( b {x}_{t}^{c i r} - a {y}_{t}^{c i r} ) + ac}{{a}^{2} + {b}^{2}} \qquad [ Equation 2 ]$$

$${y}_{t}^{r e c} = \frac{a ( - b {x}_{t}^{c i r} + a {y}_{t}^{c i r} ) + bc}{{a}^{2} + {b}^{2}}$$

Equation 2 may indicate positions x^{rec}ₜ and y^{rec}ₜ of the object 401 at the time point t. The positions x^{rec}ₜ and y^{rec}ₜ of the object 401 may be positions in which circular motion coordinates x^{cir}ₜ and y^{cir}ₜ are projected to a straight line ax+by=c.

For example, in a case that the object 401 (e.g., the flower, the grass, or the tree performing the reciprocating motion by the external force (e.g., the wind) in the specific direction) performs the reciprocating motion along a predetermined path, the motion information generation module 240 may generate the motion information 350 of the object 401 based on Equation 2.

The motion information 350 generated based on the position equation as described above may not require a memory space for the position table, and may indicate various motions by changing parameters (e.g., the initial positions x₀ and y₀, the initial angle w₀, the angular velocity w, and the straight line ax+by=c).

In an embodiment, the motion information generation module 240 may generate the motion information 350 using a physical equation indicating the position of the object 401 according to an elastic motion, a sliding motion, a uniform motion, or a falling motion.

For example, the motion information generation module 240 may generate the motion information 350 of the object 401 using a physical equation indicating a velocity and a displacement such as Equation 3 below. In an embodiment, the motion information generation module 240 may represent the motion of the object 401 as a velocity and acceleration, and may add a velocity that changes in proportion to acceleration for each frame of each hour (or unit time) and calculate a displacement of the motion.

$${v}_{t + 1} = {v}_{t} + {a}_{t} Δ t \qquad [ Equation 3 ]$$

$${x}_{t + 1} = {x}_{t} + {v}_{t} Δ t .$$

In Equation 3, aₜ may be acceleration at the time point t, vₜ may be a velocity at the time point t, and xₜ may be a displacement at the time point t. In an embodiment, the acceleration aₜ at the time point t may be calculated differently according to an elastic motion, a sliding motion, a uniform motion, or a falling motion. In Equation 3, the displacement, the velocity, and the acceleration in an x-direction are described, but Equation 3 may be also applicable to a displacement, a velocity, and acceleration in a y-direction perpendicular to the x-direction.

For example, the motion information generation module 240 may generate the motion information 350 of the object 401 using a physical equation for an elastic motion such as Equation 4 below. In an embodiment, the motion information generation module 240 may determine that a motion due to an elastic motion occurs in the object 401 when the object 401 (or a portion of the object 401) receives a force in a state fixed by another object (e.g., an object distinct from the object 401, or an object extending from the object 401). For example, in a case that a portion of object 401 is a fixed object (e.g., the flower or the grass), the motion information generation module 240 may determine that the object 401 performs a reciprocating motion (e.g., up and down, or left and right) by a force in a specific direction for the object 401. For example, variables that determine acceleration in the reciprocating motion of the object 401 are an elastic force and a damping force, and the motion information generation module 240 may change the acceleration of the object 401 in proportion to each of a displacement and a velocity of the object 401. In an embodiment, the motion information 350 of the object 401, which is an elastic body, may be generated by considering an elastic coefficient X and a damping coefficient c in Equation 4.

$${a}_{t} = - λ {x}_{t} - c {v}_{t} \qquad [ Equation 4 ]$$

Equation 4 may indicate the acceleration aₜ according to an elastic motion of the object 401 at the time point t. In Equation 4, λ may be an elastic coefficient, and c may be a damping coefficient.

For example, the motion information generation module 240 may generate the motion information 350 of the object 401 using a physical equation for a sliding motion such as Equation 5 below. In an embodiment, when it is determined that the object 401 is moved by the sliding motion, the motion information generation module 240 may determine that a uniform acceleration motion occurs due to a frictional force acting in an opposite direction of the sliding motion. For example, the motion information generation module 240 may generate the motion information 350 for the object 401 in which the sliding motion occurs through Equation 5 using a motion friction coefficient (or μ) and a weight (or N) of the object 401.

$${a}_{t} = - μ N \qquad [ Equation 5 ]$$

Equation 5 may indicate the acceleration aₜ according to a sliding motion of the object 401 at the time point t. In Equation 5, μ may be a (motion) friction coefficient, and N may be a (estimated) weight of the object 401.

For example, the motion information generation module 240 may generate the motion information 350 of the object 401 using a physical equation for a uniform motion such as Equation 6 below.

$${a}_{t} = 0 \qquad [ Equation 6 ]$$

Equation 6 may indicate the acceleration aₜ according to a uniform motion of the object 401 at the time point t.

For example, the motion information generation module 240 may generate the motion information 350 of the object 401 using a physical equation for a falling motion such as Equation 7 below. In an embodiment, in a case that it is determined that the object 401 performs a falling motion by a force (e.g., gravity) in a downward direction (or a ground direction of the electronic device 101), the motion information generation module 240 may obtain the motion information 350 of the object 401 through Equation 7 by applying uniform gravitational acceleration g in a downward direction of the object 401.

$${a}_{t} = - g \qquad [ Equation 7 ]$$

Equation 7 may indicate the acceleration aₜ according to the uniform motion of the object 401 at the time point t. g may indicate gravitational acceleration.

According to an embodiment, a velocity when the object 401 collides with an object such as the ground may be calculated through Equation 8 or Equation 9 below. For example, when an object has elasticity such as a ball, the object moves in an opposite direction when colliding with another object (e.g., the ground). At this time, in case that the object is a fully elastic object, the object may start moving in a reflection direction with a velocity having a reflection angle vector calculated from an incident angle to the other object (e.g., the ground). In this case, when a normal vector of the other object (e.g., the ground) is n, a velocity vector in a reflection angle direction of the object may be calculated as in Equation 8 below. In addition, in a case that the object is the fully elastic object, the object may start moving in the reflection direction with the velocity having the reflection angle vector calculated from the incident angle based on the other object (e.g., the ground). In this case, when the normal vector is n, the velocity vector in the reflection angle direction of the object may be calculated as in Equation 9 below.

$${v}_{t + 1} = {v}_{t} + 2 n ( - {v}_{t} \cdot n ) \qquad [ Equation 8 ]$$

$$\vert {v}_{t + 1} \vert = k \vert {v}_{t} \vert \qquad [ Equation 9 ]$$

Equation 8 may indicate a velocity of the object 401 at a time point t+1 in a case that the object 401 is a complete elastic body. In Equation 8, n may indicate a normal vector of an object that the object 401 collides with. Equation 9 may indicate a velocity of the object 401 at the time point t+1 in a case that the object 401 is not the complete elastic body. k may be an elastic coefficient of the object 401.

In an embodiment, the motion information generation module 240 may change (or adjust) at least one of the acceleration aₜ, the velocity vₜ, or the displacement xₜ for calculating the velocity vₜ₊₁ and the displacement xₜ₊₁ of Equation 3. For example, the motion information generation module 240 may change at least one of the acceleration aₜ, the velocity vₜ, or the displacement xₜ based on a real-time input or a specified input. In an embodiment, the motion information generation module 240 may change at least one of the acceleration aₜ, the velocity vₜ, or the displacement xₜ based on pre-prepared input information 331 as the specified input. In an embodiment, the pre-prepared input information 331 may indicate data for changing at least one of the acceleration aₜ, the velocity vₜ, or the displacement xₜ defined or identified before playing the moving image 360 obtained from the still image 310. In an embodiment, the motion information generation module 240 may change at least one of the acceleration aₜ, the velocity vₜ, or the displacement xₜ based on real-time input information 335 as the real-time input. In an embodiment, the real-time input information 335 may indicate data for changing at least one of the acceleration aₜ, the velocity vₜ, or the displacement xₜ defined or identified according to an input (or a state of the electronic device 101) obtained at the same time (or substantially simultaneously) while playing the moving image 360 obtained from the still image 310.

In an embodiment, the motion information generation module 240 may identify operation (e.g., a touch input, a voice input, or an operation causing a motion of the electronic device 101) of the user toward the electronic device 101 and/or a change in a state of the electronic device 101 as the real-time input (or the real-time input information 335).

In an embodiment, the motion information generation module 240 may change at least one of the acceleration aₜ, the velocity vₜ, or the displacement xₜ of the object 401 toward which a touch input is directed or to which the touch input is initiated based on an intensity, a velocity, time, a movement distance, a pattern, and/or a direction of the touch input (or a drag input) for the display 260. For example, the motion information generation module 240 may change (or adjust) the acceleration aₜ to be applied to the object 401 to which the drag input is initiated (or toward which the drag input is directed) based on a direction, a velocity, a pattern, and a movement distance of the drag input for the display 260. At least one of the acceleration aₜ, the velocity vₜ, or the displacement xₜ of the object 401 changed according to the touch input (or the drag input) may be based on a physical property (e.g., mass, elasticity, a shape, hardness, a pattern, roughness, and texture) specified for the object 401. For example, as mass is higher, a change in acceleration may be smaller.

In an embodiment, the motion information generation module 240 may identify a motion (or a change in inertia) of the electronic device 101 (or a housing of the electronic device 101) (or as the real-time input information 335) through the sensor module 176. In an embodiment, the motion information generation module 240 may identify that the electronic device 101 (or the housing of the electronic device 101) is rotated (e.g., rotated clockwise or counterclockwise) through the sensor module 176. In an embodiment, the motion information generation module 240 may change (or adjust) the acceleration aₜ to be applied to the object 401 so that a direction of gravitational acceleration faces the ground as the electronic device 101 is rotated. In an embodiment, according to the rotation of the electronic device 101, the acceleration aₜ to be applied to the object 401 may be based on a rotation direction or a rotation angle of the electronic device 101. For example, the acceleration aₜ to be applied to the object 401 may be changed (or adjusted) so that the direction of the gravitational acceleration is adjusted in an opposite direction of the rotation direction. For example, the acceleration aₜ to be applied to the object 401 may be changed (or adjusted) so that the direction of the gravity acceleration is adjusted in proportion to an angle.

In an embodiment, the motion information generation module 240 may identify that the electronic device 101 (or the housing of the electronic device 101) is moved through the sensor module 176. In an embodiment, the motion information generation module 240 may change (or adjust) the acceleration aₜ to be applied to the object 401 so that acceleration in an opposite direction of a moving direction is applied as the electronic device 101 is moved. In an embodiment, the acceleration aₜ to be applied to the object 401, according to the movement of the electronic device 101, may be based on a movement direction, a movement velocity, movement time, or a movement distance of the electronic device 101. For example, in the opposite direction of the movement direction, the acceleration aₜ to be applied to the object 401 may be changed (or adjusted). For example, the acceleration aₜ to be applied to the object 401 may be changed (or adjusted) in proportion to the movement velocity. For example, time during which the acceleration aₜ to be applied to the object 401 is changed (or adjusted) may be extended in proportion to the movement time or the movement distance.

In an embodiment, the motion information generation module 240 may receive a sound signal (or a pressure signal) through a microphone (e.g., the input module 150 of FIG. 1). In an embodiment, the motion information generation module 240 may change (or adjust) the acceleration aₜ to be applied to objects capable of floating (e.g., objects capable of performing a reciprocating motion, a uniform motion, or a falling motion) among a plurality of objects according to the sound signal. In an embodiment, the motion information generation module 240 may change (or adjust) the acceleration aₜ to be applied to the objects capable of floating (e.g., the objects capable of performing the reciprocating motion, the uniform motion, or the falling motion) based on the intensity or time of the sound signal. For example, the acceleration aₜ to be applied to the objects capable of floating may be changed (or adjusted) in proportion to the intensity of the sound signal. For example, the acceleration aₜ to be applied to the objects capable of floating may be changed (or adjusted) in proportion to the time of the sound signal.

In an embodiment, the motion information generation module 240 may identify a notification (e.g., a phone reception notification of a phone application or a message reception notification of a message application). In an embodiment, the motion information generation module 240 may change (or adjust) the acceleration aₜ to be applied to the object 401 according to the notification. For example, the motion information generation module 240 may change (or adjust) the acceleration aₜ to be applied to the object 401 according to a type of the notification (or an application that generated the notification), content of the notification, and/or a sender related to the notification. For example, the acceleration aₜ to be applied to the object 401 may be changed (or adjusted) according to an intensity set according to the type of the notification. For example, an intensity set for the phone reception notification may be greater than an intensity set for the message reception notification. For example, the acceleration aₜ to be applied to the object 401 may be changed (or adjusted) according to an intensity set according to the sender related to the notification. For example, an intensity set for a notification for a sender stored in contacts may be greater than an intensity set for a notification for a sender not stored in the contacts. For example, an intensity set for a notification for a specified sender (e.g., a family or a friend) among senders stored in the contacts may be greater than an intensity set for a notification for a non-specified sender (e.g., a coworker) among the senders stored in the contacts.

In an embodiment, the motion information generation module 240 may identify weather information. In an embodiment, the weather information may include weather in the still image 310 and/or weather in a physical environment in which the electronic device 101 is positioned. In an embodiment, the weather in the still image 310 may include weather described by the still image 310 and/or actual weather at time and/or position at which the still image 310 was captured. Hereinafter, the weather described by the still image 310 and/or the actual weather at the time and/or the position at which the still image 310 was captured may be referred to as weather of the still image 310.

In an embodiment, the motion information generation module 240 may change (or adjust) the acceleration aₜ to be applied to the object 401 according to weather information. For example, the motion information generation module 240 may change (or adjust) the acceleration aₜ to be applied to the object 401 according to a type of weather (e.g., sunny, cloud, rain, snow, cloudy, fog), temperature, sunrise time, or sunset time. For example, the acceleration aₜ to be applied to the object may be changed (or adjusted) in proportion to the temperature. For example, the acceleration aₜ to be applied to the object 401 may be changed (or adjusted) in proportion to the temperature. For example, the acceleration aₜ to be applied to the object 401 at above-zero temperature may be higher than the acceleration aₜ to be applied to the object 401 at below-zero temperature. For example, the acceleration aₜ to be applied to the object 401 may be changed (or adjusted) according to an intensity set according to the type of weather. However, an embodiment is not limited thereto. For example, the motion information generation module 240 may change (or adjust) the acceleration aₜ to be applied to the object 401 according to time, season, weather, and the like indicated by an input image. For example, the motion information generation module 240 may change (or adjust) the acceleration aₜ to be applied to the object 401 included in an input image indicating winter to be relatively low. For example, the motion information generation module 240 may change (or adjust) the acceleration aₜ to be applied to the object 401 included in an input image to face a direction of wind indicated in the input image based on the input image in which an object shaken by the wind is captured.

In an embodiment, the motion information generation module 240 may change (or adjust) the acceleration aₜ to be applied to the object 401 based on a background and/or objects (or a foreground) in the still image 310. In an embodiment, the motion information generation module 240 may determine a shadow and/or a lighting effect according to the motion of the object 401 according to the weather, time, and/or season described by the still image 310.

For example, the motion information generation module 240 may change (or adjust) the acceleration aₜ to be applied to the object 401 according to the weather, the time, and/or the season described by the still image 310. For example, in a case that the weather of the still image 310 indicates winter, the motion information generation module 240 may change (or adjust) the acceleration aₜ to be applied to the object 401 to be relatively low. For example, in a case that the weather of the still image 310 indicates heavy rain, the motion information generation module 240 may change (or adjust) the acceleration aₜ to be applied to the object 401 so that the object 401 moves relatively downward. For example, in a case that the weather of the still image 310 indicates windy weather, the motion information generation module 240 may change (or adjust) the acceleration aₜ to be applied to the object 401 so that the object 401 has a shaking motion. According to an embodiment, in a case that other objects other than the object 401 in the still image 310 are bent in a specific direction (or bent by an external force (e.g., wind)), the motion information generation module 240 may change (or adjust) the acceleration aₜ to be applied to the object 401 so that the object 401 has the same (or corresponding) shaking motion as the other objects. According to an embodiment, in a case that there is a shadow in the other objects other than the object 401 in the still image 310, the motion information generation module 240 may determine the shadow and/or the lighting effect according to the motion of the object 401 so that the object 401 has the same (or corresponding) shading as the other objects.

In an embodiment, the motion information generation module 240 may identify position information of the object 401 at each of time points identified through the motion model based on the position table, the motion model based on the position equation, and/or the motion model based on the physical equation. In an embodiment, the motion information generation module 240 may generate the motion information 350 including information for converting a position based on positions of the object 401 at each of two neighboring time points. For example, the motion information generation module 240 may generate motion information 350 including a matrix (e.g., a rotation matrix) indicating rotation and/or a matrix (e.g., a translation matrix) indicating translation to convert a position of the object 401 at an earlier time point among two neighboring time points to a position of the object 401 at a later time point among the two neighboring time points.

According to an embodiment, the motion information generation module 240 may store the motion information 350 in the memory 130 separately from the moving image 360. In an embodiment, the motion information generation module 240 may reuse the motion information 350 stored in the memory 130 separately from the moving image 360. For example, reusing the motion information 350 may include generating a motion effect applied to an object included in another still image through the motion information 350 when generating a moving image based on the other still image other than the still image 310. In an embodiment, the motion information generation module 240 may store the motion information 350 extracted from a still image used to generate a moving image more than or equal to the reference number of time in the memory 130 separately from the moving image 360. In an embodiment, the motion information generation module 240 may store the motion information 350 of an object, which is extracted from a still image, determined to be preferred by the user in the memory 130 separately from the moving image 360. In an embodiment, the electronic device 101 may automatically (or without a user's request) generate the moving image 360 for the captured still image 310 according to a specified condition. For example, the electronic device 101 may automatically (or without a user's request) generate the moving image 360 for the captured still image 310 when a scene or object has been photographed, in a case that a scene or an object that the user has generated the moving image 360 for more than or equal to the certain number of time is captured, in a case that a user-preferred object is captured, and/or in a case that an object (or a scene) that may have a noticeable effect when generating a motion is captured. In an embodiment, the electronic device 101 may store the automatically generated moving image 360 together with the still image 310 in the memory 130.

According to an embodiment, the motion information generation module 240 may store the motion information 350 generated according to a real-time input in the memory 130 together with the moving image 360. As the generated motion information 350 is stored in the memory 130 together with the moving image 360, the user may see that the object 401 is moved according to the motion information 350 without a separate real-time input when the moving image 360 is played. The motion information 350 stored in the memory 130 together with the moving image 360 may be the motion information 350 extracted from the still image used to generate the moving image more than or equal to the reference number of time, the motion information 350 of the object determined to be preferred by the user, and/or the motion information 350 having a special graphic effect.

According to an embodiment, the motion information generation module 240 may generate motion information of each of objects of interest in consideration of motion information of another object of interest. For example, when generating motion information to apply a motion effect of a high-priority object (e.g., an object determined to be preferred by the user) (e.g., an object frequently captured or a specific relationship (family)), the motion information generation module 240 may generate motion information to cease (or suspend) a motion effect of a low-priority object. Accordingly, while a motion of the high-priority object among a plurality of objects is being played, motion playback of another object may be put on hold and/or ceased.

According to an embodiment, the motion information generation module 240 may generate motion information that causes any one object among objects to cover another object according to a position in the depth direction. According to an embodiment, the motion information generation module 240 may generate motion information in which any two objects among objects interfere (or collide) according to movement of each of the objects. The motion information in which any two objects interfere (or collide) may be generated based on acceleration according to priorities (or weights) of the two objects. For example, when the two objects interfere (or collide), the motion information may be generated so that an object with a higher priority (or weight) changes more slowly (e.g., has a lower acceleration) and an object with a lower priority (or weight) changes more rapidly (e.g., has a higher acceleration).

In a case that interference occurs when motion of a plurality of objects are played simultaneously, a motion generator may generate a natural motion by reflecting a physical property or priority of each of the objects. For example, a motion may be generated by considering a sense of perspective and depth information in an image.

In an embodiment, data inputted to the motion information generation module 240 may be transformation matrices of 3D mesh data. In an embodiment, data outputted from the motion information generation module 240 may be 3D mesh data converted according to a transformation matrix.

As described above, a method in which the motion information generation module 240 generates the motion information 350 of the object 401 in a case that the object 401 is a rigid body has been described. However, an embodiment is not limited thereto. Even in a case in which the object 401 is a soft body (e.g., clothing) or a fluid, the motion information generation module 240 may generate the motion information 350 of the object 401.

In an embodiment, the motion information generation module 240 may generate the motion information 350 of the object 401, which is the soft body (e.g., clothing) or the fluid, using the existing algorithm for 3D graphics. For example, in a case of the fluid, the motion information generation module 240 may generate the motion information 350 of the object 401 based on a specified fluid simulation algorithm (e.g., stable fluids, a level set method, or a marker and cell (MAC) Grid). For example, in a case of the soft body, the motion information generation module 240 may generate the motion information 350 of the object 401 based on a specified soft body simulation algorithm (e.g., a mass-spring model, a finite element method, or position-based dynamics (PBD)).

In an embodiment, the rendering module 250 may receive the 3D model information 340 from the 3D modeling module 220. In an embodiment, the rendering module 250 may receive the motion information 350 from the motion information generation module 240.

In an embodiment, the rendering module 250 may generate a frame corresponding to each of time points based on the 3D model information 340 and the motion information 350.

In an embodiment, the rendering module 250 may generate the frame corresponding to each of the time points through a rendering pipeline. In an embodiment, the rendering pipeline may include determining a position and a shape of a 3D object in a frame at each of the time points, determining the position of the 3D object at each of the time points, projecting to a frame at each of the time points, and shading. In an embodiment, the rendering module 250 may perform the rendering pipeline using a specified rendering module (e.g., OpenGL or Vulkan).

In an embodiment, to determine the position and the shape of the 3D object, the rendering module 250 may convert position of each of the vertices included in the 3D object using the motion information 350 on the object 401. For example, the rendering module 250 may determine the position and the shape of the 3D object at each of the time points by multiplying the coordinate values of each of the vertices included in the 3D object by matrices (e.g., a rotation matrix and/or a translation matrix) using the motion information 350 on the object 401. For example, the rendering module 250 may determine the position and the shape of the 3D object in a world coordinate with a camera as an origin at each of the time points by multiplying the coordinate values of each of the vertices included in the 3D object by the matrices (e.g., the rotation matrix and/or the translation matrix) using the motion information 350 on the object 401.

In an embodiment, for projecting to the frame at each of the time points, the rendering module 250 may generate the frame at each of the time points by projecting an area including the 3D object in the world coordinate with the camera as the origin at each of the time points into a 2D frame.

In an embodiment, for shading the frame at each of the time points, the rendering module 250 may determine a color of each of the pixels included in the frame based on the color, texture, and/or lighting of objects and/or a background in the frame at each of the time points.

In an embodiment, the rendering module 250 may determine a color of each of the pixels indicating a shadow and/or a lighting effect according to a motion of an object of interest (or a main object) through shading of the frame at each of the time points based on a type (e.g., type according to time, season, and weather) of a scene that an input image indicates, objects in the input image, or a relationship with the background. For example, the shadow and/or the lighting effect may indicate a color of a light source in a rainy condition. For example, the shadow and/or the lighting effect may indicate a shadow of the object 401 in an object covered by the object 401.

In an embodiment, the rendering module 250 may generate the moving image 360 including frames at time points through the rendering pipeline. For example, the moving image 360 may include one or more frames depicting the object 401 moving. For example, referring to FIG. 6A, the moving image 360 may include a frame 611 in which the object 401 is moved to the right. For example, referring to FIG. 6B, the moving image 360 may include a frame 615 in which the object 401 is moved to the left.

In an embodiment, the rendering module 250 may in-paint portions 610 and 620 covered by the object 401 in an original image (or the still image 310) as the object 401 is moved. In an embodiment, in-painting may be a process (or an image filling process) that generates a new image in the portions 610 and 620 exposed as the object 401 is moved. In an embodiment, the rendering module 250 may in-paint the portions 610 and 620 covered by the object 401 in the original image (or the still image 310) as the object 401 is moved, by using the specified artificial intelligence model (e.g., a diffusion model, a transformer model, a generative adversarial network (GAN)). However, an embodiment is not limited thereto. For example, as a coordinate of the camera in the world coordinate and/or a FoV of the camera is changed, portions that are not visible in the original image (or the still image 310) may be out-painted. In an embodiment, as the FoV of the camera is changed, the user may see an object move in a two-dimensional direction and/or a three-dimensional direction.

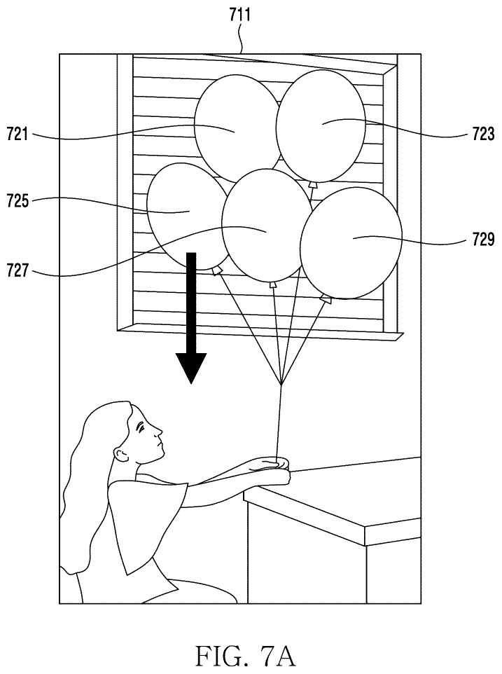

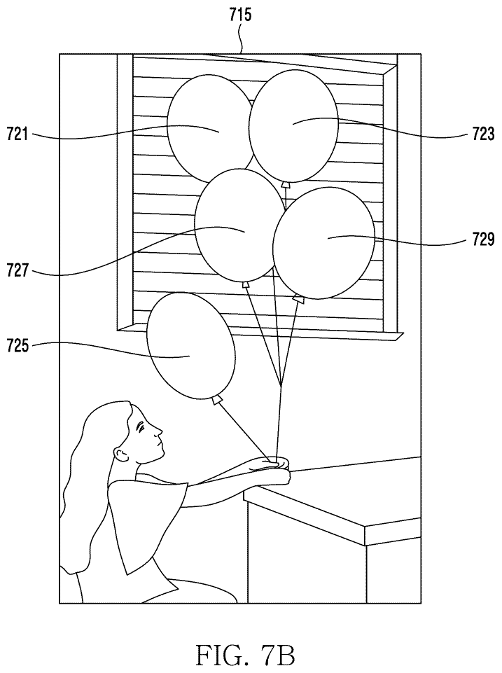

FIG. 7A is a diagram indicating an example of a frame included in a moving image generated by a real-time input, according to an embodiment. FIG. 7B is a diagram indicating an example of a frame included in a moving image generated by a real-time input, according to an embodiment.

FIGS. 7A and 7B may be described with reference to FIGS. 1 to 6B.

A frame 711 according to FIG. 7A may be displayed on a display 260 of an electronic device 101. In an embodiment, the frame 711 may be an image (e.g., an image capable of playing (a motion of) at least a portion of an area) generated from an original image (or an input image) that may be interacted with a user. For example, the frame 711 may be a frame in which a motion effect is applied to one or more objects 721, 723, 725, 727, and 729 in the original image (or the input image). As an example, the frame 711 may be an image in which a motion effect is applied to an object of interest in the image, and a remaining portion (or remaining objects) that are not related to the motion effect of the object of interest do not move (or maintain a shape in the original image). For example, the motion effect applied to the one or more objects 721, 723, 725, 727, and 729 may indicate that a position and/or a shape of the one or more objects 721, 723, 725, 727, and 729 differ between the frame 711 and the original image (or the input image). In an embodiment, the frame 711 may be a frame in which a motion effect is applied to the one or more objects 721, 723, 725, 727, and 729 according to a state (or a motion) of the electronic device 101. In an embodiment, the one or more objects 721, 723, 725, 727, and 729 may be a plurality of objects recognized from the original image (or the input image) by an object recognition module 201. In an embodiment, the one or more objects 721, 723, 725, 727, and 729 may be objects separated by an object separation module 210 among the plurality of objects recognized from the original image (or the input image). In an embodiment, the one or more objects 721, 723, 725, 727, and 729 may be objects selected by an object selection module 215 among the plurality of objects recognized (or separated) from the original image (or the input image).

In an embodiment, the electronic device 101 may receive a user input for the object 725 while displaying the frame 711 through the display 260. In an embodiment, the user input may be a touch input (e.g., a drag input) for the object 725. However, an embodiment is not limited thereto. For example, the user input for the object 725 may include a user's voice input (e.g., “move a specific balloon in a downward direction”). For example, the user input for the object 725 may include text (or a prompt) (e.g., “move a specific balloon in a downward direction”). However, an embodiment is not limited thereto. For example, a type of the user input for generating motion information on the object 725 may be specified by the user in a moving image generation process or automatically specified by an artificial intelligence model. In an embodiment, the type of the user input may be classified according to an input device for receiving the user input, an input intensity, and an input direction.

In an embodiment, based on the user input, the electronic device 101 may generate motion information of each of the one or more objects 721, 723, 725, 727, and 729 using a motion model corresponding to a motion property according to object classification information of each of the one or more objects 721, 723, 725, 727, and 729.

In an embodiment, based on the user input, the electronic device 101 may generate motion information including acceleration that causes the object 725 to be moved in the downward direction and acceleration that causes the one or more objects 721, 723, 727, and 729 to be moved to the left as the object 725 is moved in the downward direction.

In an embodiment, the electronic device 101 may render a frame 715 to be displayed after the frame 711 using 3D model information indicating a 3D object of each of the one or more objects 721, 723, 725, 727, and 729, and motion information of each of the one or more objects 721, 723, 725, 727, and 729. In an embodiment, a gap between a time when the frame 711 is displayed and a time when the frame 715 is displayed may be based on a type of each of the one or more objects 721, 723, 725, 727, and 729 and a frame rate suitable for a motion model to be applied to each of the one or more objects 721, 723, 725, 727, and 729.

In an embodiment, the electronic device 101 may display the rendered frame 715 on the display 260. Referring to FIG. 7B, in the frame 715, compared to the frame 711, the object 725 may be positioned relatively below, and the objects 721, 723, 727, and 729 may be positioned relatively to the left. In an embodiment, in order to indicate an motion effect of each of the objects 721, 723, 725, 727, and 729, between the frame 715 and the frame 711, one or more intermediate-stage frames in which positions of the objects 721, 723, 725, 727, and 729 move sequentially from a position in the frame 711 to a position in the frame 715 may be displayed through the display 260.

Thereafter, as the user input for the object 725 ceases, the electronic device 101 may display one or more frames indicating a motion effect in which the objects 721, 723, 725, 727, and 729 return to their original positions (e.g., the position in the frame 711) through the display 260.

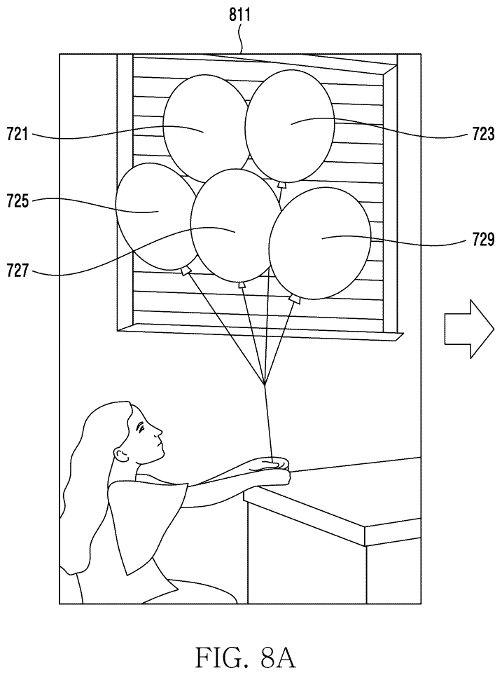

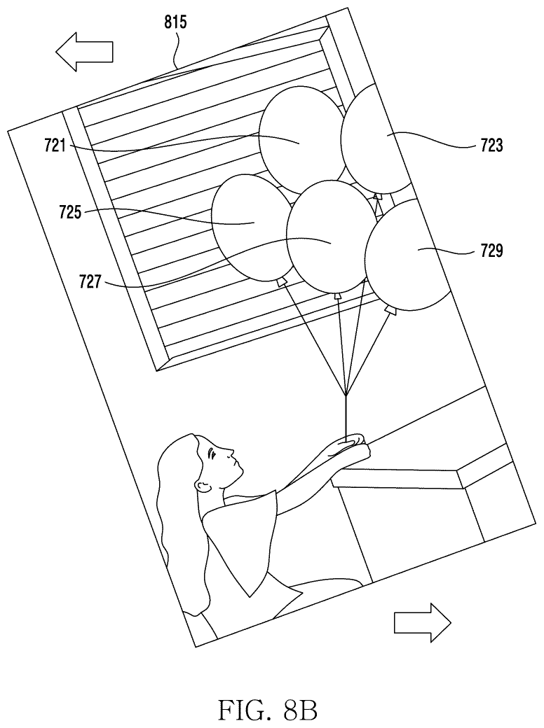

FIG. 8A is a diagram indicating an example of a frame included in a moving image generated by a real-time input, according to an embodiment. FIG. 8B is a diagram indicating an example of a frame included in a moving image generated by a real-time input, according to an embodiment.

FIGS. 8A and 8B are described referring to FIGS. 1 to 7B.

A frame 811 according to FIG. 8A may be displayed through a display 260 of an electronic device 101. In an embodiment, the frame 811 may be an image (e.g., an image capable of playing (a motion of) at least a portion of an area) generated from an original image (or an input image) that may be interacted with a user. For example, the frame 811 may be a frame in which a motion effect is applied to one or more objects 721, 723, 725, 727, and 729 in the original image (or the input image). For example, the motion effect applied to the one or more objects 721, 723, 725, 727, and 729 may indicate that a position and/or a shape of the one or more objects 721, 723, 725, 727, and 729 differ between the frame 811 and the original image (or the input image). In an embodiment, the frame 811 may be a frame in which a motion effect is applied to the one or more objects 721, 723, 725, 727, and 729 according to a state (or a motion) of the electronic device 101.

In an embodiment, while displaying the frame 811 through the display 260, the electronic device 101 may identify a state change of the electronic device 101 as a real-time input. In an embodiment, the state change of the electronic device 101 may include a motion (or a change in inertia) of the electronic device 101 (or a housing of the electronic device 101). In an embodiment, the motion (or the change in inertia) of the electronic device 101 (or the housing of the electronic device 101) may include rotation (e.g., clockwise or counterclockwise rotation) of the electronic device 101 (or the housing of the electronic device 101). In an embodiment, the motion (or the change in inertia) of the electronic device 101 (or the housing of the electronic device 101) may include movement of the electronic device 101 (or the housing of the electronic device 101).

In an embodiment, based on the state change of the electronic device 101, the electronic device 101 may generate motion information of each of the one or more objects 721, 723, 725, 727, and 729 using a motion model corresponding to a motion property according to object classification information of each of the one or more objects 721, 723, 725, 727, and 729.

In an embodiment, based on the state change of the electronic device 101, the electronic device 101 may generate motion information in which a direction of gravity acceleration applied to the one or more objects 721, 723, 725, 727, and 729 is changed, as the electronic device 101 (or the housing of the electronic device 101) is rotated counterclockwise.

In an embodiment, the electronic device 101 may render a frame 815 to be displayed after the frame 811 using 3D model information indicating a 3D object of each of the one or more objects 721, 723, 725, 727, and 729, and motion information of each of the one or more objects 721, 723, 725, 727, and 729.

In an embodiment, the electronic device 101 may display the rendered frame 815 through the display 260. Referring to FIG. 8B, while the electronic device 101 (or the housing of the electronic device 101) is rotated counterclockwise, in the frame 815, the objects 721, 723, 725, 727, and 729 may be positioned to face a right edge of the electronic device 101 compared to the frame 811. In order to indicate an motion effect of the objects 721, 723, 725, 727, and 729, between the frame 815 and the frame 811, one or more intermediate-stage frames in which positions of the objects 721, 723, 725, 727, and 729 move sequentially from a position in the frame 811 to a position in the frame 815 may be displayed through the display 260.

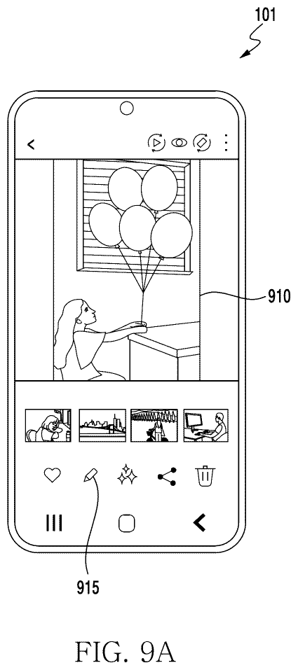

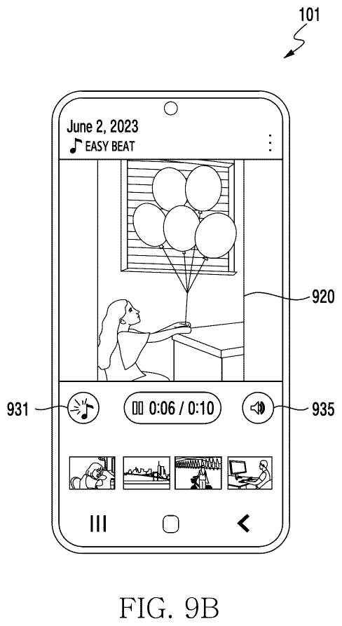

FIG. 9A is a diagram indicating an example of a frame included in a moving image displayed in a gallery application, according to an embodiment.

FIG. 9A may be described with reference to FIGS. 1 to 8B.

In an embodiment, an electronic device 101 may display a screen of a gallery application through a display 260. In an embodiment, referring to FIG. 9A, the screen of the gallery application may include a selected image 910.

In an embodiment, the electronic device 101 may receive a user input for generating a moving image based on the selected image 910. In an embodiment, the electronic device 101 may receive a user input for generating the moving image while displaying the selected image 910 on the screen of the gallery application. For example, the electronic device 101 may receive a user input for selecting an object 915 for generating the moving image based on the selected image 910.

In an embodiment, the electronic device 101 may generate a moving image in which a motion effect is applied to one or more objects based at least in part on receiving the user input for selecting the object 915. In an embodiment, the electronic device 101 may display the generated moving image instead of the image 910 on the screen of the gallery application.

In FIG. 9A, it is exemplified that a moving image suitable for the gallery application is generated, but this is only an example. In an embodiment, the electronic device 101 may determine a resolution, a size, and/or a format (e.g., emoji) of the moving image based on a size of a screen on which the image 910 or the moving image generated from the image 910 is to be displayed and/or a type of an application. For example, a resolution, a size, and/or a format (e.g., emoji) of a moving image may be determined based on an intention of a user to generate the moving image predicted according to context (e.g., an application currently in use, a usage pattern of the electronic device 101, and content currently displayed on the screen) of the electronic device 101. For example, when the user generates a moving image from the image 910 while chatting with another user through a messenger application (or for file sharing), the electronic device 101 may generate the moving image having a resolution, a size, and a format (e.g., motion emoji) suitable for sharing with the other user.

FIG. 9B is a diagram indicating an example of a frame in specified content of a gallery application, according to an embodiment.

FIG. 9B may be described with reference to FIGS. 1 to 8B.

In an embodiment, referring to FIG. 9B, the electronic device 101 may display specified content 920 through the display 260. In an embodiment, the specified content 920 may be content (e.g., a story) that displays one or more images over time. In an embodiment, the specified content 920 may include a moving image generated based on an image (e.g., the image 910 of FIG. 9A) to be played for a specified time.

In an embodiment, the electronic device 101 may play audio corresponding to a motion of an object while playing the specified content 920. For example, the electronic device 101 may include an object 931 for controlling playback of audio and an object 935 for controlling volume of audio. In an embodiment, the audio corresponding to the motion of the object may be audio corresponding to motion information of an object among a plurality of audios classified according to the motion information. For example, in a case that the object is a ball and the object bounces on a floor, the audio corresponding to the motion information of the object may include a sound effect of the object hitting the floor. For example, in a case that the object is a cloud and the object moves in a specified direction, the audio corresponding to the motion information of the object may include a sound effect having the number of bits corresponding to a motion velocity of the object. For example, the audio may be audio generated based on the image (e.g., the image 910 of FIG. 9A) (through an artificial intelligence model). For example, the audio may be audio generated (substantially) simultaneously with generating the specified content 920 based on the image (e.g., the image 910 of FIG. 9A). For example, the audio may include a melody suitable for a scene or a theme of the specified content 920. For example, the audio may include a sound effect according to the motion of the object in the specified content 920. According to an embodiment, the audio may include a voice. For example, the audio may include a voice generated (through the artificial intelligence model) based on a voice signal stored in the electronic device 101.

In an embodiment, a multimedia thumbnail may be coupled with a moving image in the specified content 920. In an embodiment, the audio and/or the multimedia thumbnail generated in relation to the motion of the object may be stored in memory 130 as metadata of the specified content 920.

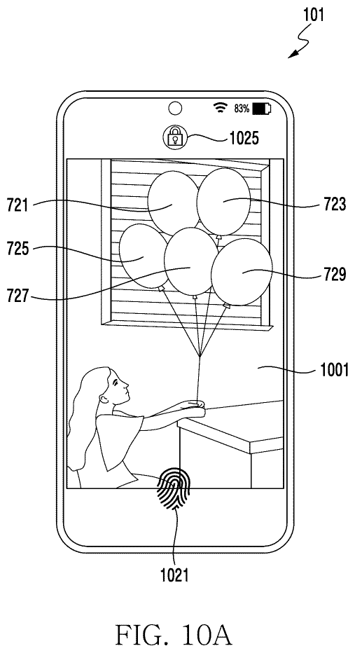

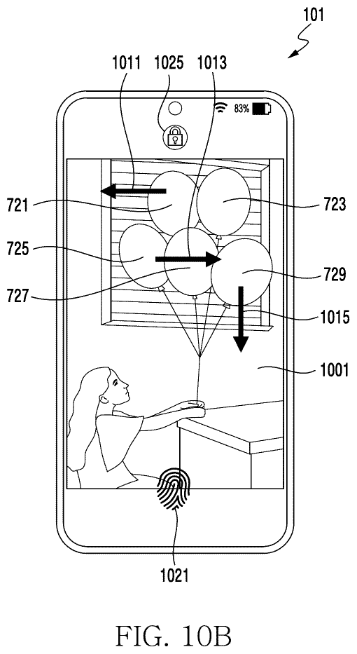

FIG. 10A is a diagram indicating an example of a lock screen displayed in a locked state of an electronic device, according to an embodiment. FIG. 10B is a diagram indicating an example of a user input for releasing a locked state of an electronic device according to an embodiment.

Referring to FIG. 10A, an electronic device 101 may display a lock screen 1001 in the locked state. In an embodiment, the lock screen 1001 may be an image including objects 721, 723, 725, 727, and 729 that may be interacted with a user generated from a still image. According to an embodiment, the lock screen 1001 may include a visual object 1021 indicating a position of a fingerprint sensor for identifying a fingerprint for unlocking the electronic device 101 and a visual object 1025 indicating that the electronic device 101 is in the locked state.

In an embodiment, the electronic device 101 may generate the lock screen 1001 to be displayed on a display 260 in the locked state based on an original image (or an input image). In an embodiment, when generating the lock screen 1001 from the original image (or the input image), the electronic device 101 may set a method for releasing the locked state. For example, the method for releasing the locked state may include unlocking through the fingerprint obtained through the fingerprint sensor by the user positioning a finger on the visual object 1021 indicating the position of the fingerprint sensor. For example, the method for releasing the locked state may include unlocking through a user input that causes a motion of the one or more objects 721, 723, 725, 727, and 729 in the lock screen 1001.

In an embodiment, the electronic device 101 may receive a pattern of one or more user inputs that cause the motion of the one or more objects 721, 723, 725, 727, and 729 in the lock screen 1001 while setting the method for releasing the locked state. In an embodiment, the electronic device 101 may obtain the obtained pattern of the user inputs as a pattern for unlocking the electronic device 101 while setting the method for releasing the locked state.

In an embodiment, referring to FIG. 10B, the electronic device 101 may receive user inputs 1011, 1013, and 1015 for the objects 721, 723, 725, 727, and 729 while displaying the lock screen 1001 in the locked state. For example, the electronic device 101 may identify a pattern of the user inputs 1011, 1013, and 1015 for the objects 721, 723, 725, 727, and 729.

For example, the electronic device 101 may unlock the electronic device 101 based on the pattern of the user inputs 1011, 1013, and 1015 corresponding to the pattern for unlocking the electronic device 101. For example, the electronic device 101 may maintain the electronic device 101 in the locked state based on the pattern of the user inputs 1011, 1013, and 1015 being different from the pattern for unlocking the electronic device 101.

For example, a pattern in which the user input 1011 for moving the object 721 to the left, the user input 1013 for moving the object 725 to the right, and the user input 1015 for moving the object 729 downward are sequentially inputted may be the pattern for unlocking the electronic device 101.

In this case, in a case that the user input 1011 for moving the object 721 to the left, the user input 1013 for moving the object 725 to the right, and the user input 1015 for moving the object 729 downward are sequentially inputted, the electronic device 101 may unlock the electronic device 101. In a case that the user input 1011 for moving the object 721 to the left, the user input 1013 for moving the object 725 to the right, and the user input 1015 for moving the object 729 downward are inputted in a different order, or a user input for another object (e.g., the object 723 or the object 727) is inputted, the electronic device 101 may maintain the lock of the electronic device 101.

According to an embodiment, the visual object 1021 indicating the position of the fingerprint sensor for identifying the fingerprint for unlocking the electronic device 101 may be displayed on the lock screen 1001 instead of the pattern for unlocking the electronic device 101. In an embodiment, as it is set to be possible to unlock the electronic device 101 through the pattern for unlocking the electronic device 101 for the objects 721, 723, 725, 727, and 729, a display of the visual object 1021 may be ceased (or refrained).

In an embodiment, when it is set to unlock through the fingerprint, the electronic device 101 may obtain fingerprint data indicating the fingerprint by detecting the finger of the user positioned in the visual object 1021 through the fingerprint sensor. In an embodiment, the electronic device 101 may unlock the electronic device 101 in a case that the fingerprint data indicates the fingerprint of the user. In an embodiment, the electronic device 101 may maintain the locked state of the electronic device 101 in a case that the fingerprint data does not indicate the fingerprint of the user.

In an embodiment, in a case that the fingerprint data indicates the fingerprint of the user, the electronic device 101 may apply a specified motion effect to the objects 721, 723, 725, 727, and 729. For example, the specified motion effect may be a motion effect preset to inform that the fingerprint data indicates the fingerprint of the user. In an embodiment, in a case that the fingerprint data does not indicate the fingerprint of the user, the electronic device 101 may apply another specified motion effect to the objects 721, 723, 725, 727, and 729. For example, the other specified motion effect may be another motion effect preset to inform that the fingerprint data does not indicate the fingerprint of the user.

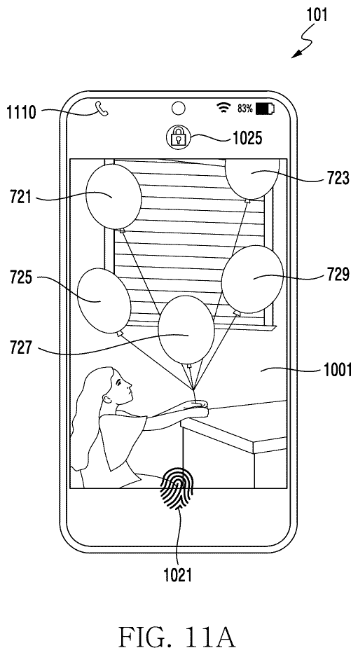

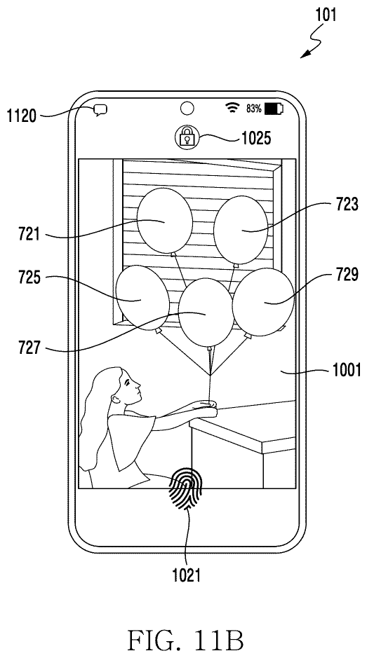

FIG. 11A is a diagram indicating an example of a frame displayed according to a notification of an electronic device, according to an embodiment. FIG. 11B is a diagram indicating an example of a frame displayed according to a notification of an electronic device, according to an embodiment.

Referring to FIGS. 11A and 11B, an electronic device 101 may display a motion of objects 721, 723, 725, 727, and 729 differently according to a type of notifications 1110 and 1120 while displaying a lock screen 1001 in a locked state. However, an embodiment is not limited thereto. For example, the electronic device 101 may display a motion of objects differently as it identifies an event (e.g., an event for displaying a notification) while displaying a screen including the objects that may be interacted with a user on a background screen.

In an embodiment, a motion information generation module 240 may identify a notification (e.g., a phone reception notification of a phone application or a message reception notification of a message application). In an embodiment, the motion information generation module 240 may change (or adjust) acceleration aₜ to be applied to an object 401 according to the notification. For example, the motion information generation module 240 may change (or adjust) the acceleration aₜ to be applied to the object 401 according to a type of the notification (or an application that generated the notification), and/or a sender related to the notification. For example, the acceleration aₜ to be applied to the object 401 may be changed (or adjusted) according to an intensity set according to the type of the notification. For example, an intensity set for the phone reception notification may be greater than an intensity set for the message reception notification. For example, the acceleration aₜ to be applied to the object 401 may be changed (or adjusted) according to an intensity set according to the sender related to the notification. For example, an intensity set for a notification for a sender stored in contacts may be greater than an intensity set for a notification for a sender not stored in the contacts. For example, an intensity set for a notification for a specified sender (e.g., a family or a friend) among senders stored in the contacts may be greater than an intensity set for a notification for a non-specified sender (e.g., a coworker) among the senders stored in the contacts.

According to an embodiment, the notification may include a notification generated in the electronic device 101 as well as a notification based on a call and/or a message received from another electronic device. For example, when a remaining battery capacity falls to less than or equal to a specified standard, the electronic device 101 may play a motion of objects. For example, according to a schedule (e.g., a specified medication time point, a wake-up call, or a departure time point) stored by the user, the electronic device 101 may play the motion of the objects.

In addition, for example, in response to being communicationally connected, directly or indirectly, with an external electronic device (e.g., an access point, a base station, a wearable device, or an IoT device), the electronic device 101 may play the motion of the objects. As an example, when connected to a specified external electronic device, the electronic device 101 may play a specified motion for at least one object. For example, as it identifies that a distance between an object (e.g., a person, an animal, or another electronic device) outside the electronic device 101 and the electronic device 101 is changed, the electronic device 101 may play the motion of the objects. As an example, as the distance to the external object is identified as a specified distance, the electronic device 101 may play a specified motion for at least one object.

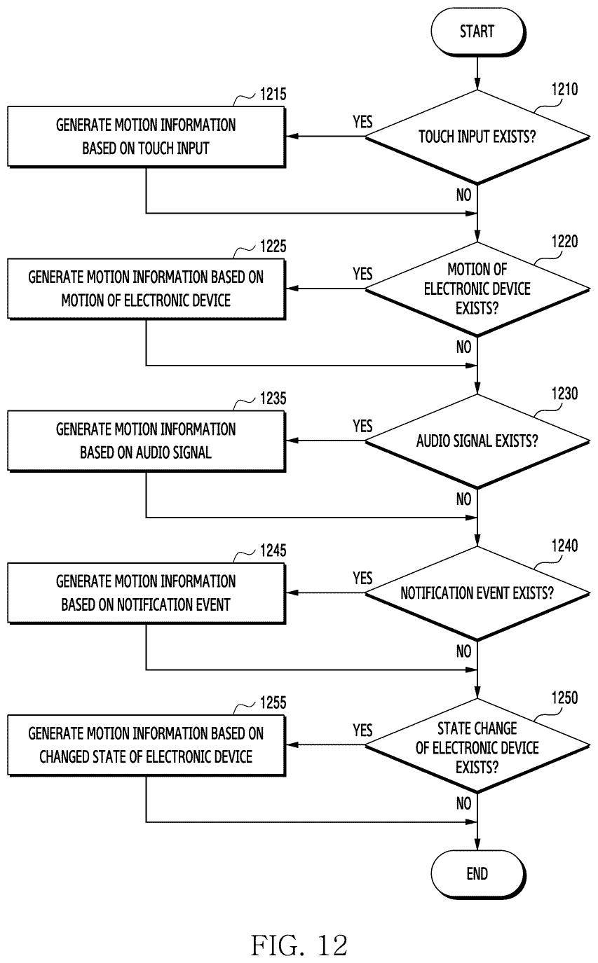

FIG. 12 is a flowchart indicating an operation in which an electronic device determines acceleration according to a real-time input, according to an embodiment.

FIG. 12 may be described with reference to FIGS. 1 to 11B.

Referring to FIG. 12, in operation 1210, an electronic device 101 may determine whether a touch input exists. For example, the electronic device 101 may determine whether the touch input for an object to which a motion effect may be applied in an interactable image exists while the interactable image (e.g., an image capable of playing (a motion of) at least a portion of an area) is displayed on a display 260.

In the operation 1210, based on a presence of the touch input, the electronic device 101 may perform operation 1215. In the operation 1210, based on an absence of the touch input, the electronic device 101 may perform operation 1220.

In the operation 1215, the electronic device 101 may generate motion information based on the touch input. For example, the electronic device 101 may generate the motion information using a motion model corresponding to a motion property of an object toward which the touch input is directed. In an embodiment, the electronic device 101 may identify the touch input through the display 260 (or a touch sensor of the display 260). In an embodiment, the electronic device 101 may identify acceleration based on a direction of the touch input. For example, the electronic device 101 may obtain the direction and/or acceleration of the touch input based on an amount of change in a position (or a coordinate) of a press input obtained through the display 260 (or the touch sensor of the display 260). In an embodiment, in a case that a position of the touch input overlaps at least a portion of the object and/or approaches in a specified distance from the object, the electronic device 101 may determine that the touch input is a touch input that affects a motion of the object. In an embodiment, the electronic device 101 may generate the motion information based on the touch input that affects the motion of the object.

In the operation 1220, the electronic device 101 may determine whether a motion of the electronic device 101 exists. For example, the electronic device 101 may determine whether the motion of the electronic device 101 exists while the interactable image (e.g., the image capable of playing (the motion of) at least a portion of an area) is displayed on the display 260.

In the operation 1220, based on a presence of the motion of the electronic device 101, the electronic device 101 may perform operation 1225. In the operation 1220, based on an absence of the motion of the electronic device 101, the electronic device 101 may perform operation 1230.

In the operation 1225, the electronic device 101 may generate the motion information based on the motion of the electronic device 101. For example, the electronic device 101 may generate the motion information using a motion model corresponding to a motion property of an object to which a motion effect in the interactable image may be applied. In an embodiment, the electronic device 101 may detect the motion and/or rotation of the electronic device 101 using a sensor module 176 (e.g., a gyro sensor and/or an acceleration sensor). In an embodiment, the electronic device 101 may determine the motion effect to which the object is affected based on information indicating the motion and/or the rotation.

In the operation 1230, the electronic device 101 may determine whether an audio signal exists. For example, the electronic device 101 may determine whether the audio signal being outputted through a sound output module 155 exists while the interactable image (e.g., the image capable of playing (the motion of) at least a portion of an area) is displayed on the display 260.

In the operation 1230, based on a presence of the audio signal, the electronic device 101 may perform operation 1235. In the operation 1230, based on an absence of the audio signal, the electronic device 101 may perform the operation 1240.

In the operation 1235, the electronic device 101 may generate the motion information based on the audio signal. For example, the electronic device 101 may generate motion information using the motion model corresponding to the motion property of the object to which the motion effect in the interactable image may be applied. For example, the electronic device 101 may obtain an audio signal using an input module 150 (e.g., a microphone) inside the electronic device 101. For example, the electronic device 101 may determine a direction and/or an intensity of the audio signal based on the audio signal obtained using at least one microphone, and may determine a motion effect (e.g., a motion effect due to wind) to be applied to an object using the determined direction and/or intensity of the audio signal. In an embodiment, the electronic device 101 may generate the motion information using the motion effect (e.g., the motion effect due to the wind) to be applied to the object determined based on the audio signal.

In the operation 1240, the electronic device 101 may determine whether a notification event exists. For example, the electronic device 101 may determine whether the notification event exists while the interactable image (e.g., the image capable of playing (the motion of) at least a portion of an area) is displayed on the display 260.

In the operation 1240, based on a presence of the notification event, the electronic device 101 may perform operation 1245. In the operation 1240, based on an absence of the notification event, the electronic device 101 may perform operation 1250.

In the operation 1245, the electronic device 101 may generate the motion information based on the notification event. For example, the electronic device 101 may generate the motion information using the motion model corresponding to the motion property of the object to which the motion effect in the interactable image may be applied. For example, the electronic device 101 may determine the motion effect to be applied to the object according to a type (or an application generating a notification) of the notification event, content of the notification event, and/or a sender related to the notification event. For example, the electronic device 101 may determine an intensity of the motion effect to be applied to the object according to the type of the notification event. For example, the electronic device 101 may determine the intensity of the motion effect to be applied to the object according to the sender related to the notification event. For example, an intensity set for a notification event for a sender stored in contacts may be greater than an intensity set for a notification event for a sender not stored in the contacts. For example, an intensity set for a notification event for a specified sender (e.g., a family or a friend) among senders stored in the contacts may be greater than an intensity set for a notification event for a non-specified sender (e.g., a coworker) among the senders stored in the contacts.

In the operation 1250, the electronic device 101 may determine whether a state change of the electronic device 101 exists. For example, the electronic device 101 may determine whether the state change of the electronic device 101 exists while the interactable image (e.g., the image capable of playing (the motion of) at least a portion of an area) is displayed on the display 260.

In the operation 1250, based on a presence of the state change of the electronic device 101, the electronic device 101 may perform operation 1255. In the operation 1250, based on an absence of the state change of the electronic device 101, the electronic device 101 may terminate the operation according to FIG. 12.

In the operation 1255, the electronic device 101 may generate the motion information based on the state change of the electronic device 101. For example, the electronic device 101 may generate the motion information using the motion model corresponding to the motion property of the object to which the motion effect in the interactable image may be applied. In an embodiment, the electronic device 101 may identify weather information and/or a change in the weather information as the state change of the electronic device 101 using the electronic device 101. Accordingly, the electronic device 101 may provide a motion effect according to the change in the weather information. For example, in a case that the current weather is winter, the electronic device 101 may determine acceleration to be applied to the motion information to be relatively low. For example, in a case that the current weather is very windy weather, the electronic device 101 may determine acceleration to be applied to the motion information according to an intensity of the wind.

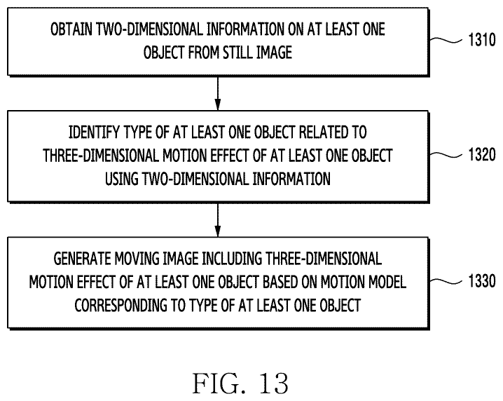

FIG. 13 is a flowchart indicating an operation of an electronic device, according to an embodiment.

FIG. 13 may be described with reference to FIGS. 1 to 11B.

Referring to FIG. 13, in operation 1310, an electronic device 101 may obtain two-dimensional information on at least one object from a still image. For example, the two-dimensional information may indicate a position (or a center position) (or boundary) of each of the one or more objects in a still image, and/or an area of each of the one or more objects in the still image.

In operation 1320, the electronic device 101 may identify a type of at least one object related to a three-dimensional motion effect of the at least one object using the two-dimensional information. In an embodiment, the type of the at least one object may define and/or indicate a motion property related to an object. In an embodiment, the type of the at least one object may indicate one or more motion types (or one or more motion classifications) of a plurality of motion types (or a plurality of motion classifications).

In an embodiment, the electronic device 101 may identify a pattern of physical movement (e.g., a pattern of motion described with reference to Equation 1 to Equation 9) related to the at least one object and a transformation of an appearance corresponding to the pattern of the physical movement (e.g., rotational movement and/or translational movement) using the two-dimensional information. In an embodiment, the electronic device 101 may identify the type of the at least one object based on the pattern of the physical movement and the transformation of the appearance.

In operation 1330, the electronic device 101 may generate a moving image including the three-dimensional motion effect of the at least one object based on a motion model corresponding to the type of the at least one object. In an embodiment, the motion model may include a motion model based on a position table, a motion model based on a position equation, and a motion model based on a physical equation. The electronic device 101 may generate motion information based on the motion model corresponding to the type of the at least one object. The electronic device 101 may generate a moving image including a motion effect of the at least one object in a frame according to the motion information. In an embodiment, the motion effect may include movement, rotation, and shape change of the at least one object.

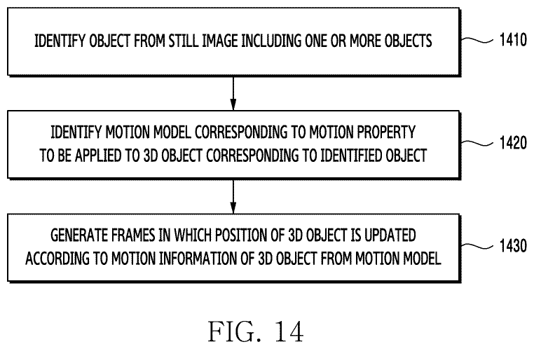

FIG. 14 is a flowchart indicating an operation of an electronic device according to an embodiment.

FIG. 14 may be described with reference to FIGS. 1 to 11B.

Referring to FIG. 14, in operation 1410, an electronic device 101 may identify an object from a still image including one or more objects. In an embodiment, the electronic device 101 may recognize and/or separate one or more objects in the still image. In an embodiment, the electronic device 101 may identify an object of interest among the identified one or more objects. In an embodiment, the object of interest may be an object selected by a user input or an object that satisfies a specified condition.

In operation 1420, the electronic device 101 may identify a motion model corresponding to a motion property to be applied to a 3D object corresponding to the identified object.

In an embodiment, the electronic device 101 may define (or identify) a motion property related to the object of interest. For example, the motion property related to the object of interest may indicate one or more motion types (or one or more motion classifications) of a plurality of motion types (or a plurality of motion classifications). For example, the motion type may be defined by and/or indicate one or more motions (e.g., a circular motion and a reciprocating motion), or a motion (e.g., an elastic motion, a sliding motion, a uniform motion, a free fall, and an accelerated motion) based on physical laws.

In an embodiment, the electronic device 101 may identify a motion model corresponding to the motion property of the object of interest. In an embodiment, the motion model may include a motion model based on a position table, a motion model based on a position equation, and a motion model based on a physical equation.

In operation 1430, the electronic device 101 may generate frames in which a position of the 3D object is updated according to motion information of the 3D object from the motion model.

In an embodiment, the electronic device 101 may identify position information of the object of interest at each of the time points identified through the motion model based on the position table, the motion model based on the position equation, and/or the motion model based on the physical equation. In an embodiment, the electronic device 101 may generate motion information including information for converting a position based on positions of the object of interest at each of two neighboring time points.

In an embodiment, the electronic device 101 may generate frames in which the position of the 3D object is updated at each of the time points based on 3D model information and motion information corresponding to the object of interest. In an embodiment, the electronic device 101 may generate a frame corresponding to each of the time points through a rendering pipeline. In an embodiment, the rendering pipeline may include determining a position and a shape of a 3D object in a frame at each of the time points, determining the position of the 3D object at each of the time points, projecting to a frame at each of the time points, and shading.

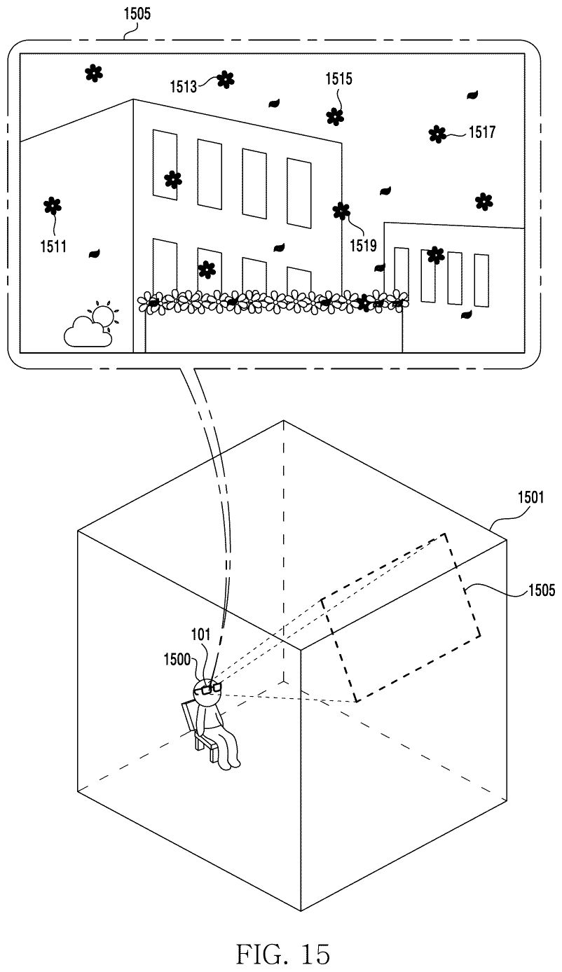

FIG. 15 is a diagram indicating an example of a frame displayed on a wearable device according to an embodiment.

In an embodiment, referring to FIG. 15, an electronic device 101 may be a wearable device wearable on a user 1500. For example, the electronic device 101 may display a FoV 1505 in a three-dimensional virtual space 1501.

In an embodiment, the electronic device 101 may generate an output image to be displayed in the FoV 1505 based on an input image. In an embodiment, the output image displayed in the FoV 1505 may include one or more objects 1511, 1513, 1515, 1517, and 1519.

In an embodiment, the electronic device 101 may identify a real-time input related to the one or more objects 1511, 1513, 1515, 1517, and 1519 included in the output image displayed in the FoV 1505.

In an embodiment, the real-time input may be identified by a sensor module 176 (e.g., a motion sensor or an infrared sensor), and/or a camera module 180. In an embodiment, the real-time input may include the user 1500 moving in a state of wearing the electronic device 101. In an embodiment, the real-time input may include the user 1500 moving a head of the user 1500 in the state of wearing the electronic device 101. In an embodiment, the real-time input may include the user 1500 moving a gaze determined by both eyes of the user 1500 in the state of wearing the electronic device 101. In an embodiment, the real-time input may include a gesture performed by the user 1500 in the state of wearing the electronic device 101. In an embodiment, a real-time input in the bar-type electronic device 101 exemplified with reference to FIGS. 1 to 11B may be a two-dimensional input toward a display 260, whereas a real-time input in the wearable-type electronic device 101 exemplified with reference to FIG. 15 may be a three-dimensional input by a gesture, a motion, and/or a gaze.

In an embodiment, the electronic device 101 may apply a motion effect of the one or more objects 1511, 1513, 1515, 1517, and 1519 in a three-dimensional direction according to a real-time input in the three-dimensional direction. In an embodiment, the electronic device 101 may generate motion information including acceleration for moving an object with a high importance (or a high priority) among the one or more objects 1511, 1513, 1515, 1517, and 1519 toward the user 1500 and moving an object with a low importance (or a low priority) away from the user 1500 according to the real-time input in the three-dimensional direction. However, an embodiment is not limited thereto. For example, in a case that a notification is received, the electronic device 101 may generate motion information including acceleration for moving an object indicating a notification with a high importance toward the user 1500 and moving an object indicating a notification with a low importance away from the user 1500. For example, the electronic device 101 may determine an object controlled by a user input and/or close to the user input as the object with high importance. Alternatively, the electronic device 101 may determine that an importance of the object increases as it is closer to the gaze of the user according to the gaze of the user.

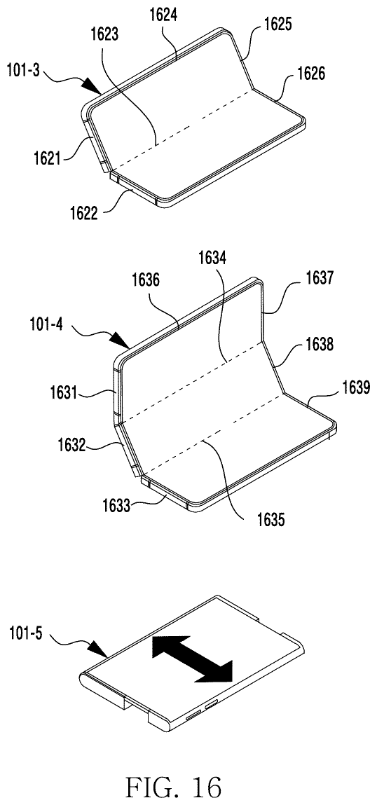

FIG. 16 is a diagram illustrating various types of electronic devices according to an embodiment.

In FIGS. 1 to 11B, the electronic device 101 is illustrated as a bar type device, but the electronic device 101 to which the operation of the present disclosure is applied is not limited thereto. For example, the electronic device may be devices with various form factors (e.g., a foldable type device 101-3 including two housing parts, a foldable type device 101-4 including three or more housing parts, or a slidable (or rollable) type device 101-5).

For example, the foldable type device 101-3 may include a pair of housing parts (e.g., a first housing part 1621 and a second housing part 1622) that are rotatably connected, directly or indirectly, to each other based on a folding axis 1623 and a flexible display 1624. The flexible display 1624 may include a first display area 1625 accommodated in the first housing part 1621 and a second display area 1626 accommodated in the second housing part 1622. A hinge assembly that rotatably connects the first housing part 1621 and the second housing part 1622 may be disposed between the first housing part 1621 and the second housing part 1622. A hinge housing for accommodating at least a portion of the hinge assembly may be disposed between the first housing part 1621 and the second housing part 1622.

For example, the multi-foldable type device 101-4 may include a first housing part 1631 and a second housing part 1632 that are rotatably connected directly or indirectly to each other based on a first folding axis 1634, and a third housing part 1633 rotatably connected to the second housing part 1632 based on a second folding axis 1635. The multi-foldable type device 101-4 may include a flexible display 1636. The flexible display 1636 may include a first display area 1637 accommodated in the first housing part 1631, a second display area 1638 accommodated in the second housing part 1632, and a third display area 1639 accommodated in the third housing part 1633. The multi-foldable type device 101-4 may support an in-folding method or an out-folding method. The in-folding method may correspond to a method in which display areas corresponding to each other are folded in a direction facing each other. A hinge assembly providing the in-folding method may include a hinge housing part. The out-folding method may correspond to a method in which display areas corresponding to each other are folded in a direction not facing each other. A hinge assembly providing the out-folding method may not include a hinge housing part. For example, the first folding axis 1634 may correspond to a folding axis of the in-folding method, and the second folding axis 1635 may correspond to a folding axis of the out-folding method. The first housing part 1631 and the second housing part 1632 may be folded in the out-folding method, and the second housing part 1632 and the third housing part 1633 may be folded in the in-folding method. For example, the multi-foldable type device 101-4 may also be formed by including three folding axes and four housing parts.

In an embodiment, in the electronic devices 101-3, 101-4, and 101-5, motion information of an object in an image displayed on a display (e.g., 1624, 1625, 1626, 1636, 1637, 1638, or 1639) may be determined in response to a physical motion of a housing (e.g., 1621, 1622, 1631, 1632, or 1633) and/or the display (e.g., 1624, 1625, 1626, 1636, 1637, 1638, or 1639).

In an embodiment, in a case that an image including a movable object is displayed on a background screen (or a lock screen, or an always on display (AoD) screen), the electronic devices 101-3, 101-4, and 101-5 may play a motion in which an object moves in a direction (or an opposite direction thereof) of the physical motion of the housing (e.g., 1621, 1622, 1631, 1632, or 1633) and/or the display (e.g., 1624, 1625, 1626, 1636, 1637, 1638, or 1639) in response to the physical motion of the housing (e.g., 1621, 1622, 1631, 1632, or 1633) and/or the display (e.g., 1624, 1625, 1626, 1636, 1637, 1638, or 1639).

In an embodiment, in various types of the electronic devices 101-3, 101-4, and 101-5, an object for applying a motion effect may be selected according to specifications of the electronic devices 101-3, 101-4, and 101-5 (or electronic components mounted on the electronic devices 101-3, 101-4, and 101-5) (e.g., a type of an input/output device that the electronic devices 101-3, 101-4, and 101-5 may provide, and a specification of a display). For example, in various types of the electronic devices 101-3, 101-4, and 101-5, a motion effect may be applied differently to different objects according to a type of an input (e.g., a touch input or a gyro input) that a sensor module 176 may detect, with respect to the same input image.

The technical problems to be achieved in this document are not limited to those described above, and other technical problems not mentioned herein will be clearly understood by those having ordinary knowledge in the art to which the present disclosure belongs.

As described above, an electronic device 101 may comprise at least one processor 120 comprising processing circuitry, and memory 130, comprising one or more storage mediums, storing instructions. The instructions, when executed by the at least one processor 120 individually or collectively, may cause the electronic device 101 to obtain two-dimensional information regarding at least one object from a still image. The instructions, when executed by the at least one processor 120 individually or collectively, may cause the electronic device 101 to, using the two-dimensional information, identify a type of the at least one object related to a three-dimensional motion effect of the at least one object. The instructions, when executed by the at least one processor 120 individually or collectively, may cause the electronic device 101 to generate a moving image including the three-dimensional motion effect of the at least one object based on a motion model corresponding to the type of the at least one object.

The instructions, when executed by the at least one processor 120 individually or collectively, may cause the electronic device 101 to, using the two-dimensional information, identify a pattern of physical movement related to the at least one object and a transformation of an appearance corresponding to the pattern of the physical movement. The instructions, when executed by the at least one processor 120 individually or collectively, may cause the electronic device 101 to, based on the pattern of the physical movement and the transformation of the appearance, identify a type of the at least one object.

The instructions, when executed by the at least one processor 120 individually or collectively, may cause the electronic device 101 to receive a specified user input for the at least one object. The instructions, when executed by the at least one processor 120 individually or collectively, may cause the electronic device 101 to determine the three-dimensional motion effect based on the user input and the motion model. The instructions, when executed by the at least one processor 120 individually or collectively, may cause the electronic device 101 to generate the moving image including the three-dimensional motion effect determined according to the user input and the motion model.

The instructions, when executed by the at least one processor 120 individually or collectively, may cause the electronic device 101 to detect state information of the electronic device 101. The instructions, when executed by the at least one processor 120 individually or collectively, may cause the electronic device 101 to determine the three-dimensional motion effect based on the detected state information and the motion model. The instructions, when executed by the at least one processor 120 individually or collectively, may cause the electronic device 101 to generate the moving image including the three-dimensional motion effect determined according to the detected state information and the motion model.

The instructions, when executed by the at least one processor 120 individually or collectively, may cause the electronic device 101 to detect movement of a housing of the electronic device 101 in a specified direction and at a specified intensity. The instructions, when executed by the at least one processor 120 individually or collectively, may cause the electronic device 101 to detect the movement of the housing of the electronic device 101 as the state information of the electronic device 101.

The instructions, when executed by the at least one processor 120 individually or collectively, may cause the electronic device 101 to identify a specified notification. The instructions, when executed by the at least one processor 120 individually or collectively, may cause the electronic device 101 to detect the specified notification as the state information of the electronic device 101.

The instructions, when executed by the at least one processor 120 individually or collectively, may cause the electronic device 101 to identify that the electronic device 101 changes between a locked state and an unlocked state. The instructions, when executed by the at least one processor 120 individually or collectively, may cause the electronic device 101 to detect the change between the locked state and the unlocked state as state information of the electronic device 101.

The instructions, when executed by the at least one processor 120 individually or collectively, may cause the electronic device 101 to generate, using another image, at least a portion of a transformation according to a position and a transformation according to a time point of the at least one object. The instructions, when executed by the at least one processor 120 individually or collectively, may cause the electronic device 101 to model the at least one object in three dimensions based on the transformation according to the position and the transformation according to the time point of the at least one object.

The at least one object may include a first object and a second object, the moving image may include a first motion effect corresponding to the first object and a second motion effect corresponding to the second object, and the first motion effect and the second motion effect may be selected based on priorities related to the first object and the second object.

At least during a portion of time during which the three-dimensional motion effect is provided by playing the moving image, the moving image may include a portion in-painted from a background area of the still image and a portion out-painted from the at least one object.

As described above, an electronic device 101 may comprise a display 260, at least one processor 120 comprising processing circuitry, and memory 130, comprising one or more storage mediums, storing instructions. The instructions, when executed by the at least one processor 120 individually or collectively, may cause the electronic device 101 to identify an object in a still image including one or more objects. The instructions, when executed by the at least one processor 120 individually or collectively, may cause the electronic device 101 to identify a motion model corresponding to a motion property to be applied to a three dimensional (3D) object corresponding to the identified object. The motion property may include one or more motion types among a plurality of motion types. The instructions, when executed by the at least one processor 120 individually or collectively, may cause the electronic device 101 to display a first frame including the 3D object corresponding to the object at a first position through the display. The instructions, when executed by the at least one processor 120 individually or collectively, may cause the electronic device 101 to update a position of the 3D object according to motion information of the 3D object from the motion model. The instructions, when executed by the at least one processor 120 individually or collectively, may cause the electronic device 101 to display, through the display, a second frame including the 3D object at a second position instead of the first position according to the motion information, following the first frame.

The instructions, when executed by the at least one processor 120 individually or collectively, may cause the electronic device 101 to determine a type of the identified object among a plurality of types. The plurality of types may indicate different combinations of the plurality of motion types. The instructions, when executed by the at least one processor 120 individually or collectively, may cause the electronic device 101 to identify predefined motion information for the type of the identified object. The instructions, when executed by the at least one processor 120 individually or collectively, may cause the electronic device 101 to update the position of the 3D object from the motion model according to the predefined motion information.

The instructions, when executed by the at least one processor 120 individually or collectively, may cause the electronic device 101 to receive an input. The instructions, when executed by the at least one processor 120 individually or collectively, may cause the electronic device 101 to determine the motion information corresponding to the input. The instructions, when executed by the at least one processor 120 individually or collectively, may cause the electronic device 101 to update the position of the 3D object from the motion model according to the motion information corresponding to the input.

The instructions, when executed by the at least one processor 120 individually or collectively, may cause the electronic device 101 to receive a notification of an ongoing call of a phone application as the input. The instructions, when executed by the at least one processor 120 individually or collectively, may cause the electronic device 101 to, based on a caller of the ongoing call corresponding to a first caller, determine the motion information as first motion information. The instructions, when executed by the at least one processor 120 individually or collectively, may cause the electronic device 101 to, based on the caller of the ongoing call corresponding to a second caller other than the first caller, determine the motion information as second motion information. A displacement between the second position and the first position according to the first motion information may be greater than a displacement between the second position and the first position according to the second motion information.

The instructions, when executed by the at least one processor 120 individually or collectively, may cause the electronic device 101 to receive a user input toward the 3D object as the input. The instructions, when executed by the at least one processor 120 individually or collectively, may cause the electronic device 101 to determine the motion information corresponding to an intensity and/or a direction of the user input. The displacement between the second position and the first position may correspond to the intensity of the user input, and a direction from the first position to the second position may correspond to the direction of the user input.

The plurality of motion types may include a circular motion, a reciprocating motion, a rotational motion, or a translational motion.

The instructions, when executed by the at least one processor 120 individually or collectively, may cause the electronic device 101 to identify a blank area within the second frame defined and/or indicated by moving the 3D object from the first position to the second position. The blank area may be an area that is not overlapped by a second area occupied by the 3D object at the second position among a first area occupied by the 3D object at the first position within the second frame. The instructions, when executed by the at least one processor 120 individually or collectively, may cause the electronic device 101 to, by in-painting the blank area, display the second frame in which the blank area is drawn following the first frame.

The instructions, when executed by the at least one processor 120 individually or collectively, may cause the electronic device 101 to display a screen of a gallery application through the display. The instructions, when executed by the at least one processor 120 individually or collectively, may cause the electronic device 101 to receive a user input requesting generation of an image in which the position of the 3D object is updated according to the motion information based on the still image among a plurality of still images within the screen. The instructions, when executed by the at least one processor 120 individually or collectively, may cause the electronic device 101 to generate the image in which the position of the 3D object is updated according to the motion information according to receiving the user input. The instructions, when executed by the at least one processor 120 individually or collectively, may cause the electronic device 101 to display a plurality of frames in which the position of the 3D object is updated according to the motion information through the display according to another user input requesting display of the generated image. The plurality of frames may include the first frame and the second frame.

The instructions, when executed by the at least one processor 120 individually or collectively, may cause the electronic device 101 to identify a still image including a specified object among a plurality of still images obtained at a specified location and/or within a specified period. The instructions, when executed by the at least one processor 120 individually or collectively, may cause the electronic device 101 to identify the specified object in the still image as the object. The instructions, when executed by the at least one processor 120 individually or collectively, may cause the electronic device 101 to generate an image in which the position of the 3D object is updated according to the motion information. The instructions, when executed by the at least one processor 120 individually or collectively, may cause the electronic device 101 to display a plurality of frames in which the position of the 3D object is updated according to the motion information through the display according to a user input requesting display of the generated image, wherein the plurality of frames may include the first frame and the second frame.

The instructions, when executed by the at least one processor 120 individually or collectively, may cause the electronic device 101 to, in a locked state of the electronic device 101, display a plurality of frames in which the position of the 3D object is updated according to the motion information through the display. The plurality of frames may include the first frame and the second frame. The instructions, when executed by the at least one processor 120 individually or collectively, may cause the electronic device 101 to receive a user input directed toward the 3D object. The instructions, when executed by the at least one processor 120 individually or collectively, may cause the electronic device 101 to, while displaying the plurality of frames in which the position of the 3D object is updated through the display according to the user input, identify whether the user input corresponds to an input pattern for releasing the locked state, determine to release the locked state based on identifying that the user input corresponds to the input pattern, based on identifying that the user input does not correspond to the input pattern, maintain the locked state, and based on determining to release the locked state, display a home screen instead of the plurality of frames.

The instructions, when executed by the at least one processor 120 individually or collectively, may cause the electronic device 101 to determine a type of the identified object among a plurality of types through an artificial intelligence model. Each of the plurality of types may indicate a combination of the plurality of motion types, and the artificial intelligence model may be trained to output a type corresponding to an input among the plurality of types. The instructions, when executed by the at least one processor 120 individually or collectively, may cause the electronic device 101 to identify the motion model corresponding to the determined type of the object.

Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

As described above, a method performed by an electronic device 101 may comprise the electronic device 101 obtaining two-dimensional information regarding at least one object from a still image. The method may comprise, using the two-dimensional information, identifying a type of the at least one object related to a three-dimensional motion effect of the at least one object. The method may comprise generating a moving image including the three-dimensional motion effect of the at least one object based on a motion model corresponding to the type of the at least one object. “Based on” as used herein covers based at least on.

As described above, a method performed by an electronic device 101 may comprise identifying an object in a still image including one or more objects. The method may comprise identifying a motion model corresponding to a motion property to be applied to a three dimensional (3D) object corresponding to the identified object. The motion property may include one or more motion types among a plurality of motion types. The method may comprise displaying a first frame including the 3D object corresponding to the object at a first position through a display. The method may comprise updating a position of the 3D object according to motion information of the 3D object from the motion model. The method may comprise displaying, through the display, a second frame including the 3D object at a second position instead of the first position according to the motion information, following the first frame.

As described above, a non-transitory computer readable storage medium may store a program including instructions. The instructions, when executed by at least one processor 120 individually or collectively, may cause an electronic device 101 to obtain two-dimensional information regarding at least one object from a still image. The instructions, when executed by the at least one processor 120 individually or collectively, may cause the electronic device 101 to, using the two-dimensional information, identify a type of the at least one object related to a three-dimensional motion effect of the at least one object. The instructions, when executed by the at least one processor 120 individually or collectively, may cause the electronic device 101 to generate a moving image including the three-dimensional motion effect of the at least one object based on a motion model corresponding to the type of the at least one object.

As described above, a non-transitory computer readable storage medium may store a program including instructions. The instructions, when executed by at least one processor 120 individually or collectively, may cause an electronic device 101 to identify an object in a still image including one or more objects. The instructions, when executed by the at least one processor 120 individually or collectively, may cause the electronic device 101 to identify a motion model corresponding to a motion property to be applied to a three dimensional (3D) object corresponding to the identified object. The motion property may include one or more motion types among a plurality of motion types. The instructions, when executed by the at least one processor 120 individually or collectively, may cause the electronic device 101 to display a first frame including the 3D object corresponding to the object at a first position through the display. The instructions, when executed by the at least one processor 120 individually or collectively, may cause the electronic device 101 to update a position of the 3D object according to motion information of the 3D object from the motion model. The instructions, when executed by the at least one processor 120 individually or collectively, may cause the electronic device 101 to display, through the display, a second frame including the 3D object at a second position instead of the first position according to the motion information, following the first frame.

The effects that may be obtained from the present disclosure are not limited to those described above, and any other effects not mentioned herein will be clearly understood by those having ordinary knowledge in the art to which the present disclosure belongs.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via at least a third element(s).

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
at least one processor comprising processing circuitry; and
memory, comprising one or more storage mediums, storing instructions,
wherein the instructions, when executed by the at least one processor individually and/or collectively, cause the electronic device to:
obtain two-dimensional information regarding at least one object from a still image;
based on the two-dimensional information, identify a type of the at least one object related to a three-dimensional motion effect of the at least one object; and
generate a moving image including the three-dimensional motion effect of the at least one object based on a motion model corresponding to the type of the at least one object.

2. The electronic device of claim 1,
wherein the instructions, when executed by the at least one processor individually and/or collectively, cause the electronic device to:
based on the two-dimensional information, identify a pattern of physical movement related to the at least one object and a transformation of an appearance corresponding to the pattern of the physical movement, and
based on the pattern of the physical movement and the transformation of the appearance, identify a type of the at least one object.

3. The electronic device of claim 1,
wherein the instructions, when executed by the at least one processor individually and/or collectively, cause the electronic device to:
receive a specified user input for at least one object,
determine the three-dimensional motion effect based on the user input and the motion model, and
generate the moving image including the three-dimensional motion effect determined based on the user input and the motion model.

4. The electronic device of claim 1,
wherein the instructions, when executed by the at least one processor individually and/or collectively, cause the electronic device to:
detect state information of the electronic device,
determine the three-dimensional motion effect based on the detected state information and the motion model, and
generate the moving image including the three-dimensional motion effect determined according to the detected state information and the motion model.

5. The electronic device of claim 4,
wherein the instructions, when executed by the at least one processor individually and/or collectively, cause the electronic device to:
detect movement of a housing of the electronic device in a specified direction and at a specified intensity, and
detect the movement of the housing of the electronic device as at least part of the state information of the electronic device.

6. The electronic device of claim 4,
wherein the instructions, when executed by the at least one processor individually and/or collectively, cause the electronic device to:
identify a specified notification, and
detect the specified notification as at least part of the state information of the electronic device.

7. The electronic device of claim 4,
wherein the instructions, when executed by the at least one processor individually and/or collectively, cause the electronic device to:
identify that the electronic device changes between a locked state and an unlocked state, and
detect the change between the locked state and the unlocked state as at least part of the state information of the electronic device.

8. The electronic device of claim 1,
wherein the instructions, when executed by the at least one processor individually and/or collectively, cause the electronic device to:
generate, based on another image, at least a portion of a transformation according to a position and a transformation according to a time point of the at least one object, and
model the at least one object in three dimensions based on the transformation according to the position and the transformation according to the time point of the at least one object.

9. The electronic device of claim 1,
wherein the at least one object includes a first object and a second object,
wherein the moving image includes a first motion effect corresponding to the first object and a second motion effect corresponding to the second object, and
wherein the first motion effect and the second motion effect are selected based on priorities related to the first object and the second object.

10. The electronic device of claim 1,
wherein at least during a portion of time during which the three-dimensional motion effect is provided by playing the moving image, the moving image includes a portion in-painted from a background area of the still image and a portion out-painted from the at least one object.

11. The electronic device of claim 1,
wherein the instructions, when executed by the at least one processor individually and/or collectively, cause the electronic device to:
recognize a plurality of objects from the still image,
display, via a display, a user interface (UI) configured for requesting a selection of one or more objects among the plurality of objects,
receive a user input selecting the at least one object among the plurality of objects, and
according to receiving the user input, obtain the two-dimensional information regarding the at least one object indicated by the user input from the still image.

12. An electronic device comprising:
a display;
at least one processor comprising processing circuitry; and
memory, comprising one or more storage mediums, storing instructions,
wherein the instructions, when executed by the at least one processor individually and/or collectively, are configured to cause the electronic device to:
identify an object in a still image including one or more objects,
identify a motion model corresponding to a motion property to be applied to a three-dimensional (3D) object corresponding to the identified object, wherein the motion property includes one or more motion types among a plurality of motion types,
display a first frame including the 3D object corresponding to the object at a first position via the display,
update a position of the 3D object according to motion information of the 3D object from the motion model, and
display, via the display, a second frame including the 3D object at a second position instead of the first position according to the motion information, following the first frame.

13. The electronic device of claim 12,
wherein the instructions, when executed by the at least one processor individually and/or collectively, are configured to cause the electronic device to:
determine a type of the identified object among a plurality of types, and the plurality of types indicating different combinations of the plurality of motion types,
identify predefined motion information for the type of the identified object, and
update the position of the 3D object from the motion model according to the predefined motion information.

14. The electronic device of claim 13,
wherein the instructions, when executed by the at least one processor individually and/or collectively, are configured to cause the electronic device to:
receive an input,
determine the motion information corresponding to the input, and
update the position of the 3D object from the motion model according to the motion information corresponding to the input.

15. The electronic device of claim 14,
wherein the instructions, when executed by the at least one processor individually and/or collectively, are configured to cause the electronic device to:
receive a notification of an ongoing call of a phone application as the input,
based on a caller of the ongoing call corresponding to a first caller, determine the motion information as first motion information, and
based on the caller of the ongoing call corresponding to a second caller other than the first caller, determine the motion information as second motion information, and
wherein a displacement between the second position and the first position according to the first motion information is greater than a displacement between the second position and the first position according to the second motion information.

16. The electronic device of claim 14,
wherein the instructions, when executed by the at least one processor individually and/or collectively, are configured to cause the electronic device to:
receive a user input toward the 3D object as the input, and
determine the motion information corresponding to an intensity and/or a direction of the user input,
wherein the displacement between the second position and the first position corresponds to the intensity of the user input, and
wherein a direction from the first position to the second position corresponds to the direction of the user input.

17. The electronic device of claim 12,
wherein the instructions, when executed by the at least one processor individually and/or collectively, are configured to cause the electronic device to:
identify a blank area within the second frame defined by moving the 3D object from the first position to the second position, wherein the blank area is an area that is not overlapped by a second area occupied by the 3D object at the second position among a first area occupied by the 3D object at the first position within the second frame, and
by in-painting the blank area, display the second frame in which the blank area is drawn following the first frame.

18. The electronic device of claim 12,
wherein the instructions, when executed by the at least one processor individually and/or collectively, are configured to cause the electronic device to:
display a screen of a gallery application via the display,
receive a user input requesting generation of an image in which the position of the 3D object is updated according to the motion information based on the still image among a plurality of still images within the screen,
generate the image in which the position of the 3D object is updated according to the motion information according to receiving the user input, and
display a plurality of frames in which the position of the 3D object is updated according to the motion information via the display according to another user input requesting display of the generated image, wherein the plurality of frames include the first frame and the second frame.

19. The electronic device of claim 12,
wherein the instructions, when executed by the at least one processor individually and/or collectively, are configured to cause the electronic device to:
identify a still image including a specified object among a plurality of still images obtained at a specified location and/or within a specified period,
identify the designated object in the still image as the object,
generate an image in which the position of the 3D object is updated according to the motion information, and
display a plurality of frames in which the position of the 3D object is updated according to the motion information via the display according to a user input requesting display of the generated image, wherein the plurality of frames include the first frame and the second frame.

20. The electronic device of claim 12,
wherein the instructions, when executed by the at least one processor individually and/or collectively, are configured to cause the electronic device to:
in a locked state of the electronic device, display a plurality of frames in which the position of the 3D object is updated according to the motion information via the display, wherein the plurality of frames include the first frame and the second frame,
receive a user input directed toward the 3D object, and
while displaying the plurality of frames in which the position of the 3D object is updated via the display according to the user input:
identify whether the user input corresponds to an input pattern for releasing the locked state,
determine to release the locked state based on identifying that the user input corresponds to the input pattern,
based on identifying that the user input does not correspond to the input pattern, maintain the locked state, and
based on determining to release the locked state, display a home screen instead of the plurality of frames.
